(19) United States
(12) Patent Application Publication
(10) Pub. No.: US 2024/0299911 A1
(43) Pub. Date: Sep. 12, 2024

(54) OXIDE-MOLTEN SALT COMPOSITES FOR HIGH-PERFORMANCE THERMAL ENERGY STORAGE

(71) Applicant: North Carolina State University, Raleigh, NC (US)

(72) Inventors: Fanxing Li, Raleigh, NC (US); Runxia Cai, Raleigh, NC (US); Luke Michael Neal, Raleigh, NC (US); Kevser Hilal Bektas, Raleigh, NC (US)

(21) Appl. No.: 18/594,212

(22) Filed: Mar. 4, 2024

Related U.S. Application Data
(60) Provisional application No. 63/489,242, filed on Mar. 9, 2023.

(51) Int. Cl. B01J 23/00; B01J 23/889; B01J 35/63; F28D 20/00

(52) U.S. Cl. CPC B01J 23/002; B01J 23/8892; B01J 35/633; F28D 20/003; F28D 20/0056

(57) ABSTRACT

In one aspect, the disclosure relates to an oxide-molten salt (OMS) composite material offering excellent energy storage capacity at low cost. The OMS composite material can be provided in at least three forms, including a porous, perovskite-oxide particle as a matrix having pores filled with unary salt or salt mixtures; an external shell of perovskite-oxide particles and an internal core of salt or a salt mixture; and/or a porous, perovskite-oxide particle as a matrix filled with unary salt or salt mixtures, wherein the whole particle is enclosed with an oxide outer shell. Further in this aspect, the outer shell can be dense but either mixed ionic-electronically conductive or porous. In another aspect, the disclosed methods and systems can be used for grid-scale energy storage by retrofitting existing steam turbine-based power plants and concentrated solar plants. In a further aspect, the disclosed methods, systems, and materials are environmentally benign.

### CROSS REFERENCE TO RELATED APPLICATIONS

This application claims the benefit of U.S. Provisional Application No. 63/489,242 filed on Mar. 9, 2023, which is incorporated herein by reference in its entirety.

### STATEMENT REGARDING FEDERALLY SPONSORED RESEARCH OR DEVELOPMENT

This invention was made with government support under grant number CBET1923468 awarded by the National Science Foundation. The government has certain rights in the invention.

### BACKGROUND

The urgent need to mitigate global warming requires a swift reduction in CO₂ emissions from fossil fuel utilization. As such, promising technologies that can reduce reliance on fossil fuels and accelerate the shift toward renewable energy are highly desirable. The intermittent nature of renewable electricity from wind and solar requires considerable compensation from other energy sources, limiting their shares in the power grid. Therefore, energy storage systems, which reduce the temporal and spatial imbalances between electricity generation and consumption, will play a critical role in accelerating the renewable transition.

To store different forms of energy, various energy storage approaches have been proposed such as pumped hydro, batteries, compressed air, flywheels, and thermal energy storage (TES). Pumped hydro comprises the vast majority of the current storage capacity. However, due to the need for large reservoirs separated by elevation differences, pumped hydro is typically limited to mountainous areas, as opposed to population centers, and requires high water usage. With practical limits on increasing pumped hydro capacity, other energy storage approaches are needed to fully address the capacity required for a complete transition to renewable energy. Battery storage systems can directly store and supply electricity. However, the cost of electrode materials and the need for extensive electrical equipment make them very expensive. As such, cheaper technologies are necessary to spur 100% renewable adoption. Thermal energy storage (TES), with low-cost and direct uptake of thermal energy, can be complementary to battery storage.

Among these, TES is considered to be one of the most cost-effective approaches to overcoming the intermittency of concentrated solar power. In addition, TES can directly utilize the widely available heat resources from industrial processes such as steel mills, glass furnaces, and thermal power plants. By 2022, TES has the second-highest installed capacity of 234 GWh and is expected to reach 800 GWh by 2030.

TES technology can be further categorized into three different types, i.e., sensible thermal energy storage (STES), latent thermal energy storage (LTES), and thermochemical energy storage (TCES). At present, the only commercially available TES technology is molten salt-based STES. However, the solidification issue at low temperatures and the instability at high temperatures are the main barriers for the molten salt-based STES. The operating temperature window is typically limited to 200˜600° C., leading to a small energy density of 36˜180 kJ/kg. LTES technology relies on the heat uptake and release of phase change materials (PCMs) during their physical phase change, which can achieve a 2˜3 times larger energy density within a narrower temperature window. To date, medium/high-temperature LTES has yet to be implemented due to various technical challenges such as the high-capital cost, poor thermal conductivity, and equipment corrosion by the liquid PCMs.

Various TES materials such as molten-salt, inert particles, concrete, and redox materials have been investigated, each with its advantages and drawbacks. Molten-salt sensible-heat systems are more mature and allow excellent heat transfer. However, salt induced corrosion and limited stability at high temperatures can limit their selection and increase the cost. It is also not mechanically practical to utilize the latent heat of the salts' solid-liquid phase transition. Concrete-based TES systems store the sensible heat from high-quality steam with a low-cost storage medium. However, as with other systems that do not involve phase/chemical changes, the energy density is limited (−0.85 kJ/kg/° C.). Concerns with cracking of the concrete also limit its operating temperature range. Redox-active particles can absorb a significant amount of energy as they release lattice oxygen during energy storage. However, they are often limited by slow redox kinetics, large temperature swings and/or high cost. “High performance” redox-oxides such as Co₃O₄ are prohibitively expensive. Carbonates of Ca, Sr, or Ba can store energy through the decomposition to their oxides and CO₂. However, they tend to deactivate or require very high operating temperatures (>900° C.). Moreover, the need for integration with a CO₂ source or storage adds to the system complexity.

In summary, existing TES materials face various limitations, such as high cost, low energy storage density, large temperature swings, high operating temperatures, and/or complex design for long storage durations. As such, significant advancements in TES materials and systems are necessary to increase the power grid robustness, flexibility, and affordability, while maximizing the adoption of renewable energy. These needs and other needs are satisfied by the present disclosure.

### SUMMARY

In accordance with the purpose(s) of the present disclosure, as embodied and broadly described herein, the disclosure, in one aspect, relates to an oxide-molten salt (OMS) composite material that addresses the shortcomings of existing TES technologies by offering excellent energy storage capacity at low cost. The OMS composite material can be provided in at least three forms, including a porous, perovskite-oxide particle as a matrix having pores filled with unary salt or salt mixtures; an external shell of perovskite-oxide particles and an internal core of salt or a salt mixture; and/or a porous, perovskite-oxide particle as a matrix filled with unary salt or salt mixtures, wherein the whole particle is enclosed with an oxide outer shell. Further in this aspect, the outer shell can be dense but either mixed ionic-electronically conductive or porous.

In another aspect, the disclosed methods and systems are quick and simple to build and can be used for grid-scale energy storage by retrofitting existing steam turbine-based power plants and concentrated solar plants with TCES systems utilizing the disclosed OMS particles. The disclosed OMS particles have a high energy density and a small charge-discharge temperature window. In a further aspect, the disclosed methods, systems, and materials are advantageous over current energy storage technology using batteries since the disclosed OMS composite material poses no danger to the environment.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a typical operating scheme of perovskite-based TCES.

FIGS. 2A-2D show high-throughput calculation results of the reaction enthalpy at 400° C. (FIG. 2A) Probability distribution of ΔH for the screened candidates; (FIG. 2B) A statistic summary of ΔH for the screened candidates within different δ ranges; (FIG. 2C) A heatmap of the screened candidates within the δ range of 0-0.125; (FIG. 2D) A heatmap of the screened candidates within the δ range of 0.125-0.25.

FIG. 3 shows reaction enthalpies of selected materials.

FIG. 4 shows chemical energy storage density of the screened materials under different redox conditions (top) 400° C./0.2 atm O₂ and 800° C./0.2 atm O₂; (bottom) 400° C./0.2 atm O₂ and 1100° C./0.01 atm.

FIGS. 5A-5B show a comparison between experimental measurement and DFT prediction of ΔH for different perovskites (FIG. 5A) Relative deviation of average ΔH; (FIG. 5B) Ranges of ΔH.

FIGS. 6A-6B show a comparison between experimental measurements and DFT predictions using different criteria: (FIG. 6A) Correlation factor between ΔG and oxygen capacity; (FIG. 6B) Relationship between ΔG and oxygen capacity using the non-negative ΔG within the range of 0.125-0.5.

FIG. 7 shows a flowchart for high throughput combinatorial screening of perovskite oxides for TCES.

FIGS. 8A-8C show exemplary embodiments of OMS particles disclosed herein.

FIGS. 9A-9B show a schematic of the energy storage modes of an OMS composite material.

FIG. 10 shows XRD patterns of an exemplary composite material and its individual components.

FIGS. 11A-11C show XRD Patterns of Composite Materials with Ca-based perovskites (FIG. 11A) Sr_{0.75}Ca_{0.25}Fe_{0.25}Mn_{0.75}O_{3-δ}:NaF—CaF₂ (FIG. 11B) Sr_{0.125}Ca_{0.575}Fe_{0.25}Mn_{0.75}O_{3-δ}:NaF—CaF₂ (FIG. 11C) Sr_{0.125}Ca_{0.575}Fe_{0.25}Mn_{0.75}O_{3-δ}:NaF—NaCl

FIGS. 12A-12I show XRD Patterns of Composite Materials with La-based perovskites (FIG. 12A) La_{0.5}Sr_{0.2}FeO_{3-δ}:LiF—NaF—CaF₂ (FIG. 12B) La_{0.5}Sr_{0.2}FeO_{3-δ}:MgF₂—NaF—CaF₂ (FIG. 12C) La_{0.8}Sr_{0.2}FeO_{3-δ}:Li₂CO₃+Na₂CO₃ (FIG. 12D) La_{0.7}Sr_{0.3}FeO_{3-δ}:LiF—NaF—CaF₂ (FIG. 12E) La_{0.6}Sr_{0.4}FeO_{3-δ}:LiF—NaF—CaF₂ (FIG. 12F) La_{0.7}Sr_{0.3}Co_{0.9}Mn_{0.1}O_{3-δ}:LiF—NaF—CaF₂ (FIG. 12G) La_{0.5}Sr_{0.2}Co_{0.5}Fe_{0.2}O_{3-δ}:LiF—NaF—CaF₂ (FIG. 12H) La_{0.5}Sr_{0.2}FeO_{3-δ}:Li₂MoO₄ (FIG. 12I) La_{0.6}Sr_{0.4}FeO_{3-δ}:Li₂MoO₄

FIG. 13 shows heat flow of an exemplary composite material (50 wt. % Ca₂AlMnO₅+50 wt. % chloride molten salt).

FIG. 14 shows weight change of an exemplary composite material (50 wt. % Ca₂AlMnO₅+50 wt. % chloride molten salt).

FIGS. 15A-15B show TGA Measurements for La_{0.6}Sr_{0.4}FeO_{3-δ}:Li₂MoO₄ with the weight ratio of 0.6:0.4 (FIG. 15A) Weight (mg) (FIG. 15B) Heat Flow (mW).

FIG. 16 shows the weight loss of La_{0.6}Sr_{0.4}FeO_{3-δ} and La_{0.6}Sr_{0.4}FeO_{3-δ}:Li₂MoO₄ under 20% H₂ atmosphere at 725° C.

FIG. 17 shows the melting/solidification enthalpy (kJ/kgₛₐₗₜ) of the salt mixture in the composite material of La_{0.5}Sr_{0.2}FeO_{3-δ}:NaF—CaF₂—LiF during 100 cycles (510° C./20% O₂—660° C./Ar).

FIGS. 18A-18D show SEM images of (FIG. 18A) porous La_{0.8}Sr_{0.2}FeO_{3-δ} after applying the salt grinding method (FIG. 18B) La_{0.5}Sr_{0.2}FeO_{3-δ}:LiF—NaF—CaF₂ (0.4:0.6) after hand mixing (FIG. 18C) La_{0.5}Sr_{0.2}FeO_{3-δ}:LiF—NaF—CaF₂ (0.4:0.6) after hand-mixing and calcination, which corresponds to the morphology of composite material after 1 cycle (FIG. 18D) La_{0.5}Sr_{0.2}FeO_{3-δ}:LiF—NaF—CaF₂ (0.4:0.6) after 100 cycles.

FIGS. 19A-19B show XRD Pattern of LSF415:LiF—NaF—CaF₂ (FIG. 19A) After and (FIG. 19B) before 100 cycles.

FIGS. 20A-20B show nano-computed tomography (nano-CT) results of an OMS pellet.

FIGS. 21A-21B show heatmap of computed ΔG of the screened candidates at (FIG. 21A) 400° C. and (FIG. 21B) 800° C.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

In one aspect, disclosed herein is an oxide molten salt (OMS) composite material including a plurality of perovskite-oxide particles in a molten sort. The OMS composite can take several forms including, but not limited to, redox active perovskite-oxide particles having a porous matrix, wherein a plurality of pores in the porous matrix are filled with the molten salt. In some aspects, the OMS composite material can be in the form of a core-shell particle, wherein the particle has an outer shell that includes an oxide, such as, for example a second perovskite oxide, Al₂O₃, or any combination thereof. In any of these aspects, porosity of the redox active perovskite-oxide can be increased by ball milling. In an aspect, and without wishing to be bound by theory, the redox active perovskite-oxide stores sensible heat and thermochemical heat, while the molten salt stores the sensible heat and latent heat. Further in this aspect, heat can be stored by the disclosed materials via a temperature-swing mode and/or a pressure swing mode such as, for example, a swing between a low temperature and/or an oxygen-depleted atmosphere and a high temperature and/or an oxygen-rich atmosphere. Alternatively, the swing can be between a low temperature and/or a carbon dioxide depleted atmosphere and a high temperature and/or a carbon dioxide rich atmosphere.

In an alternative aspect, redox active perovskite-oxide particles can form a shell surrounding an internal core, wherein the internal core includes the molten salt. In any of these aspects, the molten salt can be a unary salt or a mixture of two or more salts. In an aspect, the molten salt can be selected from a chloride salt, a carbonate salt, a fluoride salt, a sulfate salt, a phosphate salt, a nitrate salt, a tetrafluoroborate salt, or any combination thereof. In another aspect, the chloride salt can be CaCl₂, NaCl, KCl, MgCl₂, LiCl, ZnCl₂, CsCl, SrCl₂, CrO₃, or any combination thereof. In still another aspect, the carbonate salt can be Li₂CO₃, Na₂CO₃, K₂CO₃, or any combination thereof. In any of these aspects, the molten salt can have a melting temperature of from about 400° C. to about 1000° C., or of about 400, 450, 500, 550, 600, 650, 700, 750, 800, 850, 900, 950, or about 1000° C., or a combination of any of the foregoing values, or a range encompassing any of the foregoing values. In one aspect, the molten salt can make up from about 10 wt % to about 90 wt % of the OMS composite material, or can be about 10, 15, 20, 25, 30, 35, 40, 45, 50, 55, 60, 65, 70, 75, 80, 85, or about 90 wt % of the OMS composite material, or a combination of any of the foregoing values, or a range encompassing any of the foregoing values.

In another aspect, the redox active perovskite-oxide particles can have a perovskite structure, a brownmillerite structure, a double perovskite structure, or any combination thereof. In a further aspect, the perovskite structure can be selected from CaₓA₁₋ₓMn_{y}B_{1-y}O_{3-δ}, LaₓA₁₋ₓFe_{y}B_{1-y}O_{3-δ}, SrₓA₁₋ₓFe_{y}B_{1-y}O_{3-δ}, or a combination thereof; wherein A is selected from the group Ca, Sr, Ba, La, or a combination thereof; and wherein B is selected from Fe, Mn, Al, Ti, Mg, Ce, Co, Cr, or a combination thereof. In an alternative aspect, the double perovskite structure can be CaₓA₂₋ₓMnAlO_{5-δ}; wherein A is selected from Sr, Ba, or any combination thereof. In any of these aspects, x and y, if present, can independently be from about 0 to about 1, or can be about 0, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or about 1, or a combination of any of the foregoing values, or a range encompassing any of the foregoing values.

Without wishing to be bound by theory, the disclosed system stores energy via (1) latent heat due to the phase transition of the molten salt, (2) chemical energy from the oxide redox reactions, and (3) the sensible heat of the composite.

In one aspect, the redox active perovskite-oxide particles in any of the disclosed forms can have the formula SrₓA₁₋ₓFe_{y}B_{1-y}O_{3-δ}; wherein A comprises Ba, Ca, La, or any combination thereof; wherein B comprises Mg, Mn, Ti, or any combination thereof; wherein x is from 0 to 1; wherein y is from 0.125 to 1; and wherein δ is from 0 to 0.5. In an aspect 6 can vary based on whether a system including the particles is in an endothermic charge state or an exothermic discharge state and δ>1 indicates a nonstoichiometric amount of oxygen is present at a given time. In a further aspect, x can be from about 0.125 to about 0.375 and y can be from about 0.125 to about 0.25. In some aspects, 6 can be from about 0 to about 0.25.

In any of these aspects, the redox active perovskite-oxide particles can be selected from SrFeO_{3-δ}, Sr_{0.75}Ba_{0.25}Fe_{0.875}Mg_{0.125}O_{3-δ}, SrFe_{0.875}Mn_{0.125}O_{3-δ}, Sr_{0.875}Ba_{0.125}FeO_{3-δ}, Sr_{0.75}Ba_{0.25}FeO_{3-δ}, Sr_{0.625}Ba_{0.375}FeO_{3-δ}, Sr_{0.625}Ba_{0.375}Fe_{0.875}Mg_{0.125}O_{3-δ}, Sr_{0.875}Ba_{0.125}Fe_{0.875}Mn_{0.125}O_{3-δ}, Sr_{0.875}Ca_{0.125}Fe_{0.875}Mn_{0.125}O_{3-δ}, Sr_{0.25}Ba_{0.75}Fe_{0.875}Mg_{0.125}O_{3-δ}, SrFe_{0.75}Ti_{0.25}O_{3-δ}, Sr_{0.125}Ba_{0.875}Fe_{0.875}Ti_{0.125}O_{3-δ}, Sr_{0.625}Ba_{0.375}Fe_{0.875}Mn_{0.125}O_{3-δ}, Sr_{0.75}Ba_{0.25}Fe_{0.875}Mn_{0.125}O_{3-δ}, Sr_{0.875}Ba_{0.125}Fe_{0.625}Ti_{0.375}O_{3-δ}, Sr_{0.75}Ca_{0.25}Fe_{0.75}Ti_{0.25}O_{3-δ}, Sr_{0.75}Ca_{0.25}Fe_{0.75}Mn_{0.25}O_{3-δ}, Sr_{0.25}Ba_{0.75}Fe_{0.875}Ti_{0.125}O_{3-δ}, Sr_{0.875}Ca_{0.125}Fe_{0.625}Ti_{0.375}O_{3-δ}, Sr_{0.75}Ca_{0.25}Fe_{0.625}Mn_{0.375}O_{3-δ}, Sr_{0.75}La_{0.25}Fe_{0.375}Mn_{0.62}O_{3-δ}, Sr_{0.875}La_{0.125}Fe_{0.75}Mn_{0.25}O_{3-δ}, Sr_{0.875}Ca_{0.125}Fe_{0.875}Mg_{0.125}O_{3-δ}, Sr_{0.875}La_{0.125}Fe_{0.625}Mn_{0.375}O_{3-δ}, Sr_{0.125}Ca_{0.875}Fe_{0.25}Mn_{0.75}O_{3-δ}, Sr_{0.75}La_{0.25}Fe_{0.75}Mg_{0.25}O_{3-δ}, Sr_{0.25}Ca_{0.75}Fe_{0.25}Mn_{0.75}O_{3-δ}, Sr_{0.75}Ba_{0.25}Fe_{0.625}Ti_{0.375}O_{3-δ}, Sr_{0.75}Ba_{0.25}Fe_{0.5}Ti_{0.5}O_{3-δ}, Sr_{0.25}Ca_{0.75}Fe_{0.375}Mn_{0.625}O_{3-δ}, Sr_{0.625}Ca_{0.375}Fe_{0.625}Ti_{0.375}O_{3-δ}, Sr_{0.375}Ca_{0.625}Fe_{0.125}Mn_{0.875}O_{3-δ}, Sr_{0.375}Ca_{0.625}Fe_{0.5}Mn_{0.5}O_{3-δ}, Sr_{0.625}Ca_{0.375}Fe_{0.5}Ti_{0.5}O_{3-δ}, Sr_{0.25}Ca_{0.75}Fe_{0.625}Ti_{0.375}O_{3-δ}, Sr_{0.5}Ca_{0.5}Fe_{0.625}Ti_{0.375}O_{3-δ}, Sr_{0.25}Ca_{0.75}Fe_{0.625}Mn_{0.375}O_{3-δ}, BaFe_{0.625}Mn_{0.375}O_{3-δ}, Sr_{0.375}Ca_{0.625}Fe_{0.75}Ti_{0.25}O_{3-δ}, Sr_{0.125}Ca_{0.875}Fe_{0.75}Mn_{0.25}O_{3-δ}, Sr_{0.25}Ca_{0.75}Fe_{0.75}Mn_{0.25}O_{3-δ}, SrFe_{0.375}Mn_{0.625}O_{3-δ}, Sr_{0.125}Ca_{0.875}Fe_{0.25}Ti_{0.75}O_{3-δ}, Sr_{0.125}Ca_{0.875}Fe_{0.625}Ti_{0.375}O_{3-δ}, Sr_{0.5}La_{0.5}Fe_{0.125}Mn_{0.875}O_{3-δ}, or any combination thereof. In a further aspect, the redox active perovskite-oxide particles can be Sr_{0.125}Ca_{0.875}Fe_{0.25}Mn_{0.75}O_{3-δ} or Sr_{0.375}Ca_{0.625}Fe_{0.125}Mn_{0.875}O_{3-δ}.

In one aspect, the OMS composite material exhibits an oxygen release capacity of from about 0.1 to about 5 wt % of the redox active perovskite-oxide particles, or at least about 2 wt %, or at least about 2.5 wt %. In a further aspect, oxygen release capacity can be measured under a first redox condition of 400° C./0.2 atm O₂ and a second redox condition of 800° C./0.01 atm O₂. In still another aspect, the OMS composite material exhibits a chemical energy storage density of at least about 80 kJ/kg ABO₃ under an isobaric air condition between 400° C. and 800° C., and exhibits a chemical energy storage density of at least about 150 kJ/kg ABO₃ under a temperature and oxygen partial pressure swing between 400° C./0.2 atm O₂ and 1100° C./0.01 atm O₂.

Also disclosed herein is a system for thermochemical energy storage and release, the system including (a) an endothermic charge stage, wherein the OMS composite material of any one of claims 1-17 has a δ of 0 at a beginning time point of the endothermic charge stage, and wherein the OMS composite material is exposed to heat, thereby releasing molecular oxygen such that δ increases to greater than 0 at an ending time point of the endothermic charge stage; and (b) an exothermic discharge stage, wherein the OMS composite material has a δ greater than 0 at a beginning time point of the exothermic discharge stage, wherein molecular oxygen combines with the OMS composite material such that δ decreases to 0 and heat is released at an ending time point of the exothermic discharge stage.

In one aspect, the endothermic charge stage can operate with an oxygen partial pressure of from about 0.01 atm to about 5 atm, or of about 0.01, 0.1, 0.5, 1, 1.5, 2, 2.5, 3, 3.5, 4, 4.5, or about 5 atm, or a combination of any of the foregoing values, or a range encompassing any of the foregoing values. In another aspect, the endothermic charge stage and the exothermic discharge stage operate with a temperature difference of from about 50° C. to about 500° C., or from about 100° C. to about 200° C.

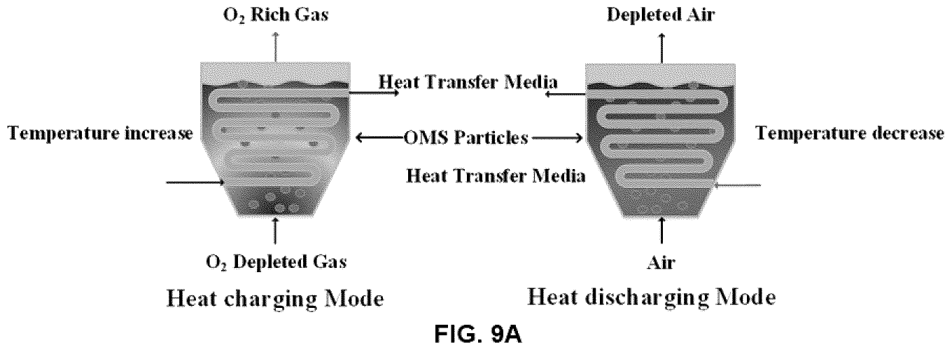

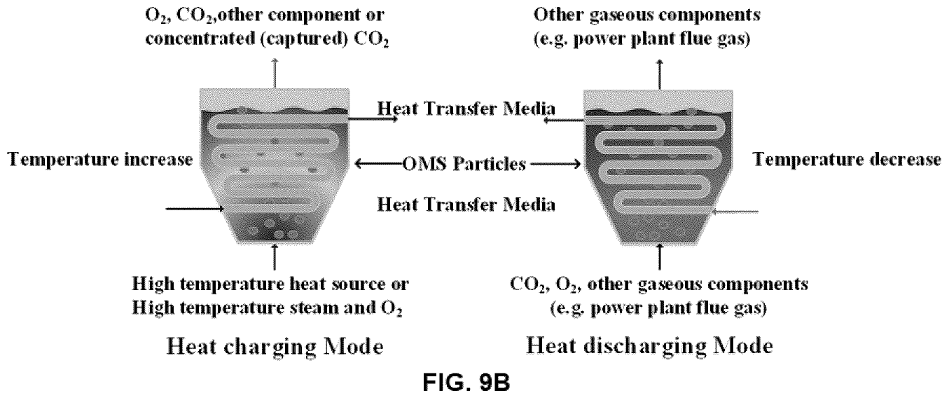

In one example, as illustrated in FIGS. 9A-9B, the disclosed materials can store heat via a temperature-swing mode or/and a pressure swing mode, e.g., a swing between low temperature or/an oxygen-depleted atmosphere (such as steam, flue gas from a combustion process, or tail-gas form a chemical process) and high temperature or/an oxygen-rich atmosphere. The driving force for the chemical energy from the oxide redox reactions can also be replaced by CO₂, e.g., a pressure swing between a CO₂-depleted atmosphere and a CO₂-rich atmosphere. The proposed OMS has narrow yet tunable working temperature windows for efficient and cost-effective integration with both high (˜900° C., up to 1200° C. or higher) and low (˜450° C., down to 300° C.) temperature thermal sources. In one aspect, in the disclosed system, when the stored heat is released, the OMS material contacts an oxygen-rich stream, creating an exothermic release of the thermochemical energy. In another aspect, in the disclosed system, the oxygen-rich stream can have a flow rate such as to minimize the temperature drop of the system as it releases heat. In yet another aspect, when the oxygen-rich stream contacts the OMS composite material, this contact takes place at a temperature below that at which some or all of the oxygen vacancies in the redox active perovskite-oxide are formed.

In one aspect, heat is supplied in the endothermic charge stage by solar power, heat radiated by an industrial process such as, for example, steel milling or glass melting, a thermal power plant, or any combination thereof. In an aspect, heat released from the exothermic discharge stage can be used to create steam to power steam turbines. Also disclosed are power plants including the disclosed systems.

In one aspect, and without wishing to be bound by theory, the high tunability of the TES material allows it to operate under a wider range of conditions, as may be suited for specific heat sources and/or heat demands with high efficiency. In an aspect, the temperature difference between the charging and discharging steps can be from about 50° C. to about 500° C. with a difference of 250° C. or less, or can be between about 100° C. and about 200° C. In another aspect, the oxygen release between the charging and discharging steps can be from about 0.1 to about 5 wt % of the perovskite material, or from about 1 wt. % to about 5 wt. %, about 2 to about 3 wt. %, or about 3 to about 5 wt. %. For the preferable perovskite-based materials, the variation in non-stoichiometry between the charging and discharging steps can be from about 0.1 to about 0.5, from about 0.1 to about 0.2, or from about 0.3 to about 0.5. The timing, temperature, and flowrate of air or oxygen-rich gas for the exothermic oxygen regeneration can be adjusted to maintain heat release within a narrow range of temperature (e.g., 200° C. or 150° C., or about 100° C., 50° C., or 25° C.). In still another aspect, oxygen vacancies can also be formed during contact with transient higher temperature source (e.g., 900-1200° C., or 800° C.-1100° C., or temperatures more than 1200° C.), where after the heat or reaction during regeneration is recovered at a lower operating temperature as is suitable for the heat use such as from about 350° C. to about 700° C., or from about 400 to about 500° C., or about 550° C. In still another aspect, the oxygen-rich stream can have a partial pressure of from about 0.01 atm to about 5 atm of O₂ and can be an oxygen-rich flue gas containing CO₂, H₂O, N₂, and O₂ along with other combustion byproducts. In this embodiment, “oxygen-rich” means a stream with a sufficient oxygen pressure to react with the TES material to fill oxygen vacancies. The stream can contain less, the same or similar, or more oxygen than air, and can be air. In an aspect, the oxygen-rich stream can have an oxygen molar composition of from about 1% to about 100%, or from about 5% to about 95%, or from about 3% to about 21%, about 5% to about 10%, about 2.5% to about 20%, or from about 10% to about 20%. In one embodiment, the stream would be air (with an oxygen content of ˜20 mol %). In another embodiment, enriched or purified oxygen (e.g., from about 90 to about 100% or from about 95% to about 99%) would be contacted to limit the loss of energy to sensible heat of oxygen diluents. In one aspect, such a “purified” stream would be generated by the TES material during the heat uptake mode either recovered directly or after condensation of a steam sweep gas.

In any of these aspects, the oxide can provided as a perovskite, brownmillerite, double perovskite, or any combination thereof. For example, a perovskite oxide can have a formula selected from the group consisting of CaₓA₁₋ₓMn_{y}B_{1-y}O_{3-δ}, LaₓA₁₋ₓFe_{y}B_{1-y}O_{3-δ}, SrₓA₁₋ₓFe_{y}B_{1-y}O_{3-δ}, and a combination thereof. Further in this aspect, A can be selected from the group Ca, Sr, Ba, La, or a combination thereof. In another aspect, B can be independently selected from the group Fe, Mn, Al, Ti, Mg, Ce, Co, Cr, or a combination thereof. In one aspect, a double perovskite oxide can have a formula selected from the group consisting of CaₓA₂₋ₓMnAlO_{5-δ}. Further in this aspect, A can be selected from Sr, Ba, or any combination thereof. In one aspect, the range of x can be between 0-1, e.g. about 0, about 0.125, about 0.25, about 0.375, about 0.5, about 0.625, about 0.75, about 0.875. or about 1. In another aspect, the range of y can be 0-1, e.g. about 0, about 0.05, about 0.1, about 0.125, about 0.25, about 0.375, about 0.5, about 0.625, about 0.75, about 0.875. or about 1.

In an aspect, the melting temperatures of salt or salt mixture can be within the range of from about 400 to about 1000° C. In a further aspect, the melting temperatures of salt mixtures can a single temperature or a temperature range. In one aspect, the suitable ranges of melting temperature can be from about 50 to about 200° C. or from about 50 to about 100° C. or can be less than about 50° C. In any of these aspects, the salt can be a chloride salt, carbonate salt, fluoride salt, sulfate salt, phosphate salt, nitrate salt, tetrafluoroborate salt, or a combination thereof. In a further example, the chloride salt can be selected from CaCl₂, NaCl, KCl, MgCl₂, LiCl, ZnCS₂, CsCl, SrCl₂, CrCl₃, or any combination thereof. In another aspect, the carbonate salt can be selected from Li₂CO₃, Na₂Co₃, K₂O₃, or any combination thereof. In still another aspect, the salt content in the OMS composite particle can be from about 10 to about 90 wt %, or from about 30 to about 50 wt. %, or from about 70 to about 90 wt. %.

Additional exemplary oxides and salts are provided in Table 1:

TABLE 1
Exemplary Oxides and Salts

| Oxides | Salts |
|---|---|
| SrFeO₃ | CaCl₂—NaCl |
| Sr_{0.875}Ba_{0.125}Fe_{0.875}O_{3-δ} | CaCl₂—NaCl—KCl |
| Sr_{0.75}Ba_{0.25}FeO_{3-δ} | NaCl—KCl—MgCl₂ |
| Sr_{0.625}Ba_{0.375}FeO_{3-δ} | Na₂CO₃—Li₂CO₃ |
| Sr_{0.875}Ba_{0.125}Fe_{0.875}Mn_{0.125}O_{3-δ} | Na₂CO₃—Li₂CO₃—K₂CO₃ |
| Sr_{0.75}Ba_{0.25}Fe_{0.875}Mg_{0.125}O_{3-δ} | Li₂CO₃—K₂CO₃ |
| Sr_{0.25}Ba_{0.75}Fe_{0.875}Mg_{0.125}O_{3-δ} | Na₂SO₄ |
| Sr_{0.125}Ba_{0.875}Fe_{0.875}Ti_{0.125}O_{3-δ} | NaNO₃ |
| Sr_{0.75}Ba_{0.25}Fe_{0.875}Mn_{0.125}O_{3-δ} | Na₂SO₄—NaCl |
| SrFe_{0.875}Mn_{0.125}O_{3-δ} | MgCl₂ |
| SrFe_{0.67}Mn_{0.33}O_{3-δ} | KCl |
| SrFe_{0.5}Mn_{0.5}O_{3-δ} | NaCl |
| SrFe_{0.33}Mn_{0.67}O_{3-δ} | Mixtures thereof |
| Sr_{0.25}Ca_{0.75}Fe_{0.75}Mn_{0.25}O_{3-δ} | |
| Sr_{0.75}La_{0.25}Fe_{0.375}Mn_{0.625}O_{3-δ} | |
| Sr_{0.25}Ca_{0.75}Fe_{0.375}Mn_{0.625}O_{3-δ} | |
| Sr_{0.875}La_{0.125}Fe_{0.75}Mn_{0.25}O_{3-δ} | |
| Sr_{0.875}La_{0.125}Fe_{0.625}Mn_{0.375}O_{3-δ} | |
| Ca₂AlMnO_{5+δ} | |
| Ca_{1.8}Sr_{0.2}AlMnO_{5+δ} | |
| Ca_{1.8}Ba_{0.2}AlMnO_{5+δ} | |
| Ca_{0.9}Sr_{0.1}MnO_{3-δ} | |
| Ca_{0.95}Sr_{0.05}MnO_{3-δ} | |
| CaTi_{0.2}Mn_{0.8}O_{3-δ} | |
| CaAl_{0.2}Mn_{0.8}O_{3-δ} | |
| CaFe_{0.1}Mn_{0.9}O_{3-δ} | |
| CaFe_{0.3}Mn_{0.9}O_{3-δ} | |
| CaCr_{0.05}Mn_{0.95}O_{3-δ} | |
| CaCo_{0.05}Mn_{0.95}O_{3-δ} | |
| CaCu_{0.2}Mn_{0.8}O_{3-δ} | |
| CaMg_{0.1}Mn_{0.9}O_{3-δ} | |
| La_{0.3}Sr_{0.7}Co_{0.9}Mn_{0.1}O_{3-δ} | |
| La_{0.1}Sr_{0.9}Co_{0.9}Mn_{0.1}O_{3-δ} | |
| La_{0.2}Sr_{0.8}Co_{0.8}Fe_{0.2}O_{3-δ} | |
| La_{0.3}Sr_{0.7}Co_{0.9}Fe_{0.1}O_{3-δ} | |

La_{0.3}Sr_{0.7}Co_{0.7}Fe_{0.3}O_{3-δ}

Preferred oxide and salt combinations are provided in Table 2:

TABLE 2
Exemplary Oxide and Salt Combinations

| Oxides | | Salts |
|---|---|---|
| SrₓCa₁₋ₓFe_{y}Co_{1-y}O_{3-δ} | x range: 0~1; y range: 0~1 | LiCl |
| SrₓCa₁₋ₓFe_{y}Cu_{1-y}O_{3-δ} | x range: 0~1; y range: 0.625~1 | Li₂CO₃ |
| SrₓCa₁₋ₓFe_{y}Mg_{1-y}O_{3-δ} | x range: 0~1; y range: 0.5~1 | K₂CO₃ |
| SrₓCa₁₋ₓFe_{y}Mn_{1-y}O_{3-δ} | x range: 0~1; y range: 0~1 | Na₂CO₃ |
| SrₓCa₁₋ₓFe_{y}Ni_{1-y}O_{3-δ} | x range: 0~1; y range: 0.5~1 | NaCl |
| SrₓCa₁₋ₓFe_{y}Ti_{1-y}O_{3-δ} | x range: 0~1; y range: 0.5~1 | KCl |
| SrₓK₁₋ₓFe_{y}Co_{1-y}O_{3-δ} | x range: 0.625~1; y range: 0.375~1 | MgCl₂ |
| SrₓK₁₋ₓFe_{y}Cu_{1-y}O_{3-δ} | x range: 0.625~1; y range: 0.625~1 | CaCl₂ |
| SrₓK₁₋ₓFe_{y}Mg_{1-y}O_{3-δ} | x range: 0.625~1; y range: 0.625~1 | ZnCl₂ |
| SrₓK₁₋ₓFe_{y}Mn_{1-y}O_{3-δ} | x range: 0.625~1; y range: 0~1 | CsCl |
| SrₓK₁₋ₓFe_{y}Ni_{1-y}O_{3-δ} | x range: 0.625~1; y range: 0.375~1 | SrCl₂ |
| SrₓK₁₋ₓFe_{y}Ti_{1-y}O_{3-δ} | x range: 0.625~1; y range: 0~1 | CrCl₃ |
| SrₓY₁₋ₓFe_{y}Co_{1-y}O_{3-δ} | x range: 0.375~1; y range: 0.125~1 | MnCl₂ |
| SrₓY₁₋ₓFe_{y}Cu_{1-y}O_{3-δ} | x range: 0.125~1; y range: 0.25~1 | Li₂SO₄ |
| SrₓY₁₋ₓFe_{y}Mg_{1-y}O_{3-δ} | x range: 0.5~1; y range: 0.625~1 | Na₂SO₄ |
| SrₓY₁₋ₓFe_{y}Mn_{1-y}O_{3-δ} | x range: 0.125~1; y range: 0~1 | Na₂SO₄ |
| SrₓY₁₋ₓFe_{y}Ni_{1-y}O_{3-δ} | x range: 0.125~1; y range: 0.25~1 | LiF |
| SrₓY₁₋ₓFe_{y}Ti_{1-y}O_{3-δ} | x range: 0.375~1; y range: 0.625~1 | NaF |
| SrₓBa₁₋ₓFe_{y}Co_{1-y}O_{3-δ} | x range: 0~1; y range: 0~1 | MgF₂ |
| SrₓBa₁₋ₓFe_{y}Cu_{1-y}O_{3-δ} | x range: 0~1; y range: 0.5~1 | CaF₂ |
| SrₓBa₁₋ₓFe_{y}Mg_{1-y}O_{3-δ} | x range: 0.125~1; y range: 0.5~1 | KF |
| SrₓBa₁₋ₓFe_{y}Mn_{1-y}O_{3-δ} | x range: 0~1; y range: 0~1 | NaBF₄ |
| SrₓBa₁₋ₓFe_{y}Ni_{1-y}O_{3-δ} | x range: 0~1; y range: 0.25~1 | KBF₄ |
| SrₓBa₁₋ₓFe_{y}Ti_{1-y}O_{3-δ} | x range: 0.125~1; y range: 0.5~1 | ZrF₄ |
| SrₓLa₁₋ₓFe_{y}Co_{1-y}O_{3-δ} | x range: 0.25~1; y range: 0~0.875 | K₃PO₄ |
| SrₓLa₁₋ₓFe_{y}Cu_{1-y}O_{3-δ} | x range: 0~1; y range: 0.125~1 | Li₃PO₄ |
| SrₓLa₁₋ₓFe_{y}Mg_{1-y}O_{3-δ} | x range: 0~1; y range: 0.25~0.875 | Mixture thereof (mixture of |
| | | some or all of the |
| | | abovementioned salts) |
| SrₓLa₁₋ₓFe_{y}Mn_{1-y}O_{3-δ} | x range: 0.5~1; y range: 0~0.875 | |
| SrₓLa₁₋ₓFe_{y}Ni_{1-y}O_{3-δ} | x range: 0~1; y range: 0~0.75 | |
| SrₓSm₁₋ₓFe_{y}Co_{1-y}O_{3-δ} | x range: 0~1; y range: 0~0.75 | |
| SrₓSm₁₋ₓFe_{y}Cu_{1-y}O_{3-δ} | x range: 0~1; y range: 0~0.75 | |
| SrₓSm₁₋ₓFe_{y}Mg_{1-y}O_{3-δ} | x = 0.25, y = 0.25; x = 0.875, y = 0.625 | |
| SrₓSm₁₋ₓFe_{y}Mn_{1-y}O_{3-δ} | x range: 0.5~1; y range: 0~0.875 | |
| SrₓSm₁₋ₓFe_{y}Ni_{1-y}O_{3-δ} | x range: 0.25~1; y range: 0.125~0.75 | |
| SrₓSm₁₋ₓFe_{y}Ti_{1-y}O_{3-δ} | x = 0.875, y = 0.875; x = 1, y = 0.875 | |

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a perovskite oxide particle,” “a molten salt,” or “a dopant,” include, but are not limited to, mixtures or combinations of two or more such perovskite oxide particles, molten salts, or dopants, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,’ and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of an OMS composite refers to an amount that is sufficient to achieve the desired improvement in the property modulated by the formulation component, e.g. achieving the desired level of energy storage for a given time within a given temperature range. The specific level in terms of wt % in a composition required as an effective amount will depend upon a variety of factors including the arrangement of the various parts of the composite material, amount and type of shell around the OMS core if a shell is present, operation temperature of a TCES device using the OMS composite, and identities of perovskite oxide including any dopants as well as the particular molten salt used in the OMS.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Overview and Experimental Considerations

The structural and compositional flexibility of perovskite oxides, and their complex yet tunable redox properties offer unique optimization opportunities for thermochemical energy storage (TCES). To improve upon the relatively inefficient, empirical-based approaches, the present study reports a high-throughput combinatorial approach for accelerated development and optimization of perovskite oxides for TCES.

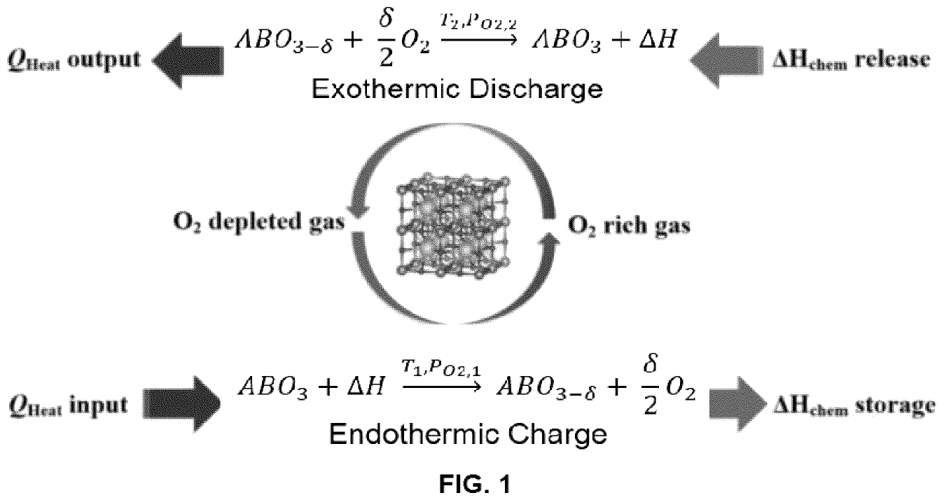

Over the past decade, TCES, which stores thermal heat via a reversible chemical reaction, has become an important research direction owing to its promise in wide operating temperature ranges and high energy storage density. Moreover, since the energy is stored in a chemical form, TCES is capable of long-term, long-distance, or even seasonal energy storage, which is difficult for STES and LTES. Various materials have been proposed for TCES. Among them, redox-active metal oxides have shown the greatest promise due to their ability to operate at high temperatures and without gas storage. Recent modeling studies indicate that up to 55% round trip efficiency can be realized with air as the only reactant. In terms of TCES materials, perovskite oxides have been frequently investigated owing to their unique compositional/structural flexibility, high activity, and cyclic stability. FIG. 1 illustrates the typical operating scheme of perovskite-based TCES.

Many perovskites have been reported for high-temperature TCES. They generally belong to the doped CaMnO₃-family, the La-family, or the Sr-family. Doped CaMnO₃-based perovskites are the most investigated high-temperature TCES materials. Although CaMnO_{3-δ} itself is unstable under an oxygen-lean environment at high temperatures (e.g., >1000° C.), doping of A-site and B-site cations have shown to improve both the stability and thermodynamic properties. Examples include CaTi_{0.2}Mn_{0.8}O_{3-δ}, CaAl_{0.2}Mn_{0.8}O_{3-δ}, CaFe_{0.1}Mn_{0.9}O_{3-δ}, CaFe_{0.3}Mn_{0.9}O_{3-δ}, CaCr_{0.05}Mn_{0.05}O_{3-δ}, Ca_{0.95}Sr_{0.05}MnO_{3-δ}, Ca_{0.9}Sr_{0.1}MnO_{3-δ}, CaCo_{0.05}Mn_{0.95}O_{3-δ}, CaCu_{0.2}Mn_{0.8}O_{3-δ}, and CaMg_{0.1}Mn_{0.9}O_{3-δ}. The maximum energy density reported to date was 571 kJ/kg ABO₃ from CaMn_{0.95}Co_{0.05}O_{3-δ} under a redox cycle between 500° C./0.2 atm O₂ and 1000° C./10⁻⁵ atm O₂. La-based perovskites exhibit high reaction enthalpies but require high operating temperatures (>1000° C.) without doping. Cobalt-doping of LaₓSr₁₋ₓFeO_{3-δ} and LaₓSr₁₋ₓMnO_{3-δ} can effectively lower the operating temperatures and enhance the activity. La_{0.3}Sr_{0.7}Co_{0.9}Mn_{0.1}O_{3-δ} demonstrated the largest chemical energy density of 250 kJ/kg ABO₃ among the La-family perovskites under a redox cycle between 200° C./0.9 atm O₂ and 1000° C./0.001 atm O₂. SrFeO₃-based perovskites present another promising option for “low-temperature” (400-650° C.) operations. The energy density of undoped SrFeO₃ was 81.7 kJ/kg ABO₃ under a redox cycle between 400° C./0.2 atm O₂ and 1000° C./Ar. The effects of various dopants on the energy storage performance of SrFeO₃ have also been investigated. For instance, Mn doping can significantly improve the redox enthalpy and cyclic stability of SrFeO₃, Cu substitution contributes to increasing the redox capacity of SrFeO₃.

Oxygen capacity, reaction enthalpy, and operating temperature range are the three most critical criteria for the selection of TCES materials. The high flexibility of the perovskite structure and the complex yet tunable properties of perovskite oxides offer unique properties for TCES optimization. However, previous research has mainly relied on an empirical-based approach. There is an urgent need for efficient screening and optimization of perovskite oxides for TCES applications.

The first principle density function theory (DFT) has shown promise in predicting the redox properties of perovskite candidates for TCES. Previous studies showed that the oxygen capacity is closely related to the oxygen vacancy formation energy (Ev). Computationally predicting the reaction enthalpy of perovskite oxides has also been attempted. Most of these studies started from a defect-free structure and directly calculated the reduction enthalpy from perfect perovskite phases to brownmillerite phases. However, oxygen defects often exist in perovskite oxides, even in their oxidized form. High-temperature TCES operations may also exceed the order-disorder transition temperature, and the brownmillerite phase may not form. Therefore, oxygen vacancy concentration and structure as a function of oxygen vacancy levels need to be carefully considered. Additionally, although a few high-throughput computational studies investigated perovskites in the context of chemical looping, no previous research has systematically computed and optimized the perovskite materials for TCES. Relevant experimental data are also limited.

Using high-throughput DFT calculations, this study demonstrates an accelerated approach to developing perovskite oxides for TCES. Over 2000 A/B-site doped SrFeO₃ were computed to identify promising TECS materials with satisfactory oxygen capacity and reaction enthalpy. Experimentally, 61 materials were synthesized, 45 samples with pure perovskite phases were tested for oxygen capacities, and 20 promising candidates were chosen for measuring the standard oxidation enthalpy. A chemical energy storage density of up to 157 kJ/kg ABO₃ (˜766 kJ/kg ABO₃ in total) was achieved by a moderate pressure swing (400° C./0.2 atm O₂ and 1100° C./0.01 atm O₂). These experimental and simulation data were used to develop effective optimization criteria, which are shown to be highly satisfactory in predicting the standard oxidation enthalpy (within 25.4% deviation) and oxygen capacity (a correlation coefficient of 0.64). Besides accelerating the optimization of TCES materials, the methods developed in this study can be applied in related fields such as chemical looping and catalysis.

### Example 2: Results and Discussion

### High-Throughput Calculations and Material Screening

Standard reaction enthalpy and redox oxygen capacity are critical for TCES systems since their product determines the TCES density. Redox oxygen capacity is closely related to the operating temperature. As such, multiple criteria are required for choosing a suitable candidate for TCES. At a specific temperature, ΔG needs to be within a suitable range to facilitate oxygen release and uptake. Since a small ΔG and a large ΔH are desirable for TCES, they were both used as the descriptors when analyzing the results from the high-throughput DFT calculations of the 2,003 SrₓA₁₋ₓFe_{y}B_{1-y}O_{3-δ} candidates.

The selection of TCES materials is also dependent upon the operating temperature range. A 400-800° C. temperature range, which is readily compatible with thermal power plants and many industrial processes, was chosen in this study. At the upper (800° C.) and the lower (400° C.) limits, the suitable range of ΔG for triggering the oxygen release can be directly calculated from Eq. (3).

$$Δ G = - \frac{1}{2} RTln \frac{{P}_{{O}_{2}}}{{P}^{0}} \qquad Eq . ( 3 )$$

Most studies on TCES materials expose the samples to very low oxygen concentrations (e.g., ≤10⁻⁵ atm) during the energy storage step. Although this would increase the measured energy storage capacity, it is unlikely to be feasible from a practical standpoint, especially for using packed beds. Therefore, this study adopts a pressure swing between P_{O2}=0.01 (energy storage) and P_{O2}=0.2 atm (energy release). This corresponds to ΔG ranges of 0.047-0.134 eV at 400° C., and 0.074-0.213 eV at 800° C. Since a previous investigation indicated a DFT simulation error of −0.3 eV to 0.5 eV, potentially suitable materials should meet the following requirements:

$$Δ {G}_{DFT} \{ \begin{matrix}∈ [ - 0.253 , 0.634 ] eV at 400 ° C \\ ∈ [ - 0.226 , 0.713 ] eV at 800 ° C\end{matrix}$$

Past experience indicates that oxygen non-stoichiometry (δ) in TCES materials is usually less than 0.3 under a moderate oxygen partial pressure of >0.001 atm. Therefore, the initial screening focused on a δ range of 0-0.25, i.e., the average between ΔG_{0-0.125} and ΔG_{0.125-0.25} calculated from DFT was compared to the aforementioned criteria.

775 samples are potentially suitable based on this criterion. Most samples containing Ti, Sm, La, and Cu were removed from consideration due to undesirable ΔG. Ti, Sm, and La dopants tend to increase the temperatures for oxygen release, leading to an excessively large ΔG. In contrast, Cu dopant has the opposite impact on ΔG.

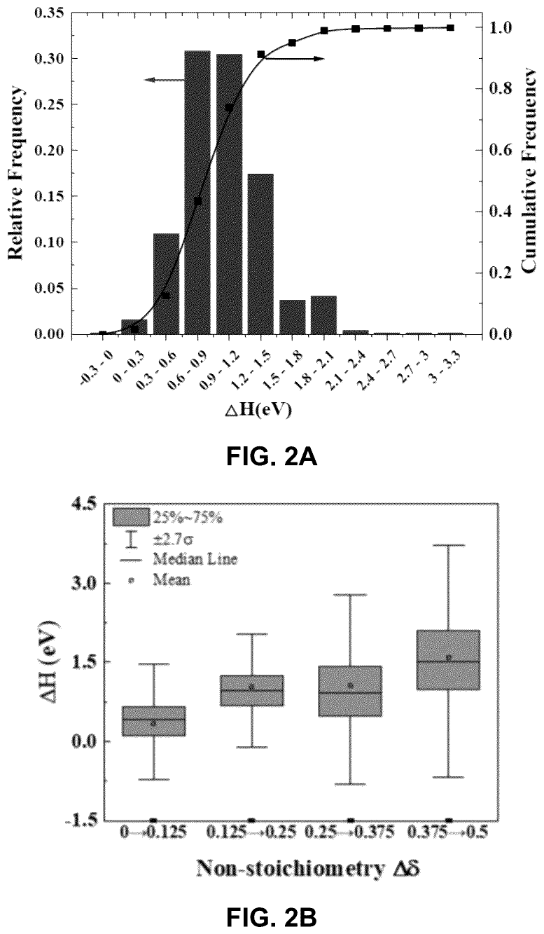

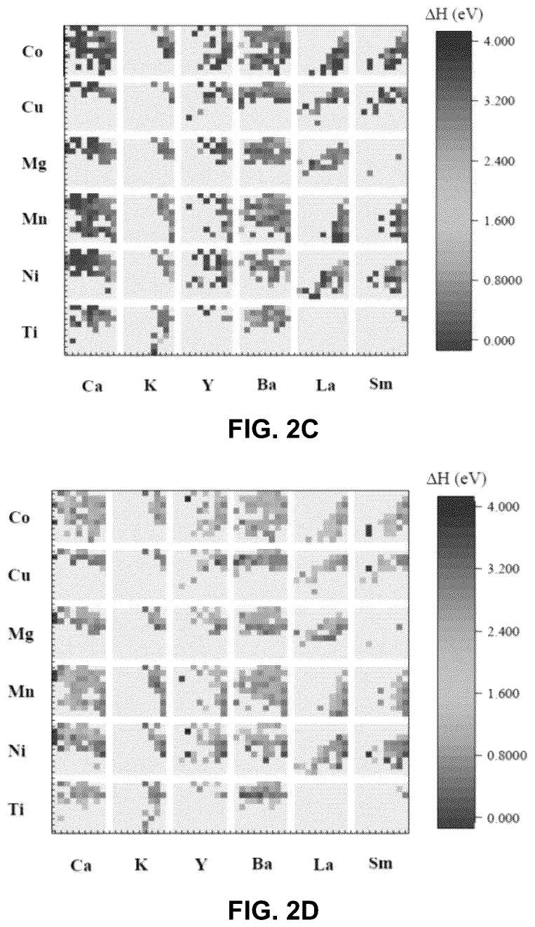

With respect to the other descriptor, i.e., ΔH, FIG. 2A summarizes its probability distribution for the 775 candidates resulting from ΔG screening. It is clearly seen that ΔH can be tuned, through cation doping, over a large range of −0.3˜3.3 eV. 80% of the materials fell within the range of 0.3-1.5 eV, i.e., 29-145 kJ/mol O. The statistical summary of ΔH at different δ ranges is shown in FIG. 2B. In general, ΔH increased with the oxygen vacancy level. This is consistent with most literature reports on perovskites. The wide range of ΔH values at different δs also indicates the necessity for covering multiple δ levels. In addition, since a considerable number of the perovskite materials for TCES either do not start from a perfect stoichiometry (i.e. δ>0 under an oxidized state) or do not release too much lattice oxygen (i.e. δ<0.5 under a reduced state), directly calculating the reduction enthalpy from perfect perovskite phases to brownmillerite phases may lead to mispredictions. The simulation results also revealed a less significant correlation between ΔH and temperature, which has also been reported in previous studies. The ΔH heatmaps of the screened perovskite candidates are shown in FIGS. 2C-2D.

Besides ΔG and ΔH, the cost of the material is also important. Therefore, Ni, Co, Cu, Sm, and Y were excluded from experimental investigations. K-doped materials were also excluded due to the potential corrosion issues. 209 candidates were sorted by ΔH (δ=0-0.25) normalized by molecular weight, 61 materials were synthesized, and 45 samples with negligible phase impurities were tested for their redox oxygen capacity. A complete list of tested samples can be seen in Table 3 below.

TABLE 3
Oxide Sample List

| | ΔH | | TΔS | ΔG | |
|---|---|---|---|---|---|
| Material | (eV) | ΔH/MW_{ABO3} | (eV) | (eV) | XRD |
| SrCaFeTi-0.125-0.875-0.25-0.75 | 1.039 | 0.0114 | 0.705 | 0.334 | pure |
| SrCaFeTi-0.125-0.875-0.625-0.375 | 1.08 | 0.0109 | 0.741 | 0.339 | pure |
| SrCaFeTi-0.625-0.375-0.625-0.375 | 1.161 | 0.0105 | 0.937 | 0.224 | pure |
| SrCaFeMn-0.25-0.75-0.75-0.25 | 1.039 | 0.0097 | 0.822 | 0.217 | almost pure |
| SrCaFeTi-0.25-0.75-0.625-0.375 | 1.171 | 0.0091 | 0.925 | 0.246 | almost pure |
| SrCaFeTi-0.875-0.125-0.625-0.375 | 1.107 | 0.0082 | 1.071 | 0.036 | pure |
| SrBaFeTi-0.75-0.25-0.625-0.375 | 1.246 | 0.0081 | 1.007 | 0.239 | pure |
| SrBaFe-0.75-0.25-1 | 1.251 | 0.008 | 1.238 | 0.013 | Pure |
| SrCaFeMn-0.25-0.75-0.25-0.75 | 0.794 | 0.0074 | 0.565 | 0.229 | Pure |
| SrCaFeMn-0.25-0.75-0.625-0.375 | 0.795 | 0.0074 | 0.72 | 0.075 | Pure |
| SrCaFeTi-0.625-0.375-0.5-0.5 | 0.898 | 0.0074 | 0.685 | 0.214 | pure |
| SrBaFeTi-0.25-0.75-0.625-0.375 | 1.283 | 0.0071 | 1.133 | 0.15 | impure |
| SrCaFeTi-0.375-0.625-0.75-0.25 | 0.771 | 0.0069 | 0.612 | 0.159 | almost pure |
| SrBaFeTi-0.75-0.25-0.5-0.5 | 1.032 | 0.0068 | 0.819 | 0.213 | pure |
| SrFeMn-1-0.875-0.125 | 0.973 | 0.0068 | 0.612 | 0.361 | pure |
| SrBaFeTi-0.875-0.125-0.625-0.375 | 0.978 | 0.0067 | 0.659 | 0.319 | almost pure |
| SrCaFeTi-0.375-0.625-0.875-0.125 | 0.722 | 0.0064 | 0.793 | −0.071 | impure |
| SrBaFe-0.875-0.125-1 | 0.953 | 0.0064 | 0.532 | 0.421 | impure |
| CaFe-1-1 | 0.609 | 0.0063 | 0.845 | −0.236 | almost pure |
| SrCaFeTi-0.75-0.25-0.75-0.25 | 0.822 | 0.0063 | 0.824 | −0.001 | pure |
| SrCaFeTi-0.5-0.5-0.625-0.375 | 0.74 | 0.0063 | 0.571 | 0.169 | impure |
| SrCaFeMn-0.25-0.75-0.375-0.625 | 0.661 | 0.0062 | 0.622 | 0.039 | Pure |
| SrCaFeMn-0.375-0.625-0.75-0.25 | 0.699 | 0.0062 | 0.748 | −0.049 | impure |
| SrCaFeMn-0.125-0.875-0.75-0.25 | 0.623 | 0.0061 | 0.512 | 0.111 | Almost pure |
| SrCaFeMg-0.875-0.125-0.875-0.125 | 0.81 | 0.0061 | 0.559 | 0.25 | Almost pure |
| SrBaFeMg-0.875-0.125-0.875-0.125 | 0.88 | 0.006 | 0.71 | 0.169 | almost pure |
| SrBaFeTi-0.375-0.625-0.625-0.375 | 1.032 | 0.006 | 0.817 | 0.215 | impure |
| SrBaFeMg-0.75-0.25-0.875-0.125 | 0.896 | 0.0059 | 0.716 | 0.18 | Almost pure |
| SrBaFeMn-0.75-0.25-0.875-0.125 | 0.918 | 0.0059 | 0.777 | 0.141 | pure |
| SrCaFeMn-0.75-0.25-0.75-0.25 | 0.769 | 0.0059 | 0.863 | −0.094 | impure |
| SrLaFeMg-0.75-0.25-0.75-0.25 | 0.913 | 0.0059 | 0.676 | 0.237 | impure |
| SrCaFeMn-0.125-0.875-0.25-0.75 | 0.59 | 0.0058 | 0.701 | −0.111 | almost pure |
| SrLaFeMn-0.75-0.25-0.375-0.625 | 0.908 | 0.0058 | 0.723 | 0.185 | pure |
| SrBaFeMn-0.875-0.125-0.875-0.125 | 0.868 | 0.0058 | 0.62 | 0.249 | pure |
| SrCaFeMn-0.375-0.625-0.5-0.5 | 0.656 | 0.0058 | 0.467 | 0.188 | Pure |
| SrCaFeMn-0.375-0.625-0.125-0.875 | 0.651 | 0.0058 | 0.775 | −0.124 | Pure |
| SrCaFeMn-0.875-0.125-0.875-0.125 | 0.79 | 0.0058 | 0.564 | 0.226 | |
| SrCaFeMn-0.75-0.25-0.625-0.375 | 0.751 | 0.0057 | 0.738 | 0.013 | |
| SrCaFeMg-0.75-0.25-0.875-0.125 | 0.726 | 0.0057 | 0.486 | 0.24 | pure |
| SrCaFeMn-0.375-0.625-0.875-0.125 | 0.646 | 0.0057 | 0.772 | −0.126 | |
| SrCaFeMn-0.375-0.625-0.25-0.75 | 0.642 | 0.0057 | 0.617 | 0.024 | |
| SrBaFe-0.5-0.5-1 | 0.951 | 0.0056 | 0.693 | 0.257 | impure |
| SrCaFeMn-0.375-0.625-0.375-0.625 | 0.637 | 0.0056 | 0.645 | −0.008 | |
| SrLaFeMn-0.875-0.125-0.625-0.375 | 0.839 | 0.0056 | 0.563 | 0.276 | pure |
| SrBaFeMg-0.625-0.375-0.875-0.125 | 0.886 | 0.0056 | 0.738 | 0.148 | impure |
| SrLaFeMn-0.875-0.125-0.75-0.25 | 0.836 | 0.0056 | 0.589 | 0.247 | Pure |
| LaFeMg-1-0.5-0.5 | 0.984 | 0.0055 | 0.961 | 0.023 | impure |
| SrBaFeMn-0.625-0.375-0.875-0.125 | 0.886 | 0.0055 | 0.607 | 0.279 | pure |
| SrLaFeMn-0.5-0.5-0.125-0.875 | 0.919 | 0.0055 | 0.887 | 0.032 | pure |
| BaFeMn-1-0.625-0.375 | 1.052 | 0.0055 | 1.164 | −0.112 | almost pure |
| SrCaFeMg-0.75-0.25-0.5-0.5 | 0.629 | 0.0054 | 0.781 | −0.152 | |
| SrLaFeMg-0.625-0.375-0.625-0.375 | 0.818 | 0.0054 | 0.572 | 0.246 | |
| SrBaFe-0.625-0.375-1 | 0.874 | 0.0054 | 0.519 | 0.356 | almost pure |
| SrFeMn-1-0.375-0.625 | 0.77 | 0.0054 | 0.641 | 0.129 | pure |
| SrBaFeMn-0.875-0.125-0.375-0.625 | 0.8 | 0.0054 | 0.529 | 0.271 | |
| SrCaFeMn-0.625-0.375-0.125-0.875 | 0.667 | 0.0053 | 0.668 | −0.001 | |
| SrCaFeTi-0.625-0.375-0.75-0.25 | 0.661 | 0.0053 | 0.745 | −0.084 | |
| SrFeMn-1-0.25-0.75 | 0.759 | 0.0053 | 0.717 | 0.042 | |
| SrCaFeMn-0.75-0.25-0.875-0.125 | 0.696 | 0.0053 | 0.618 | 0.078 | |
| SrCaFeTi-0.625-0.375-0.875-0.125 | 0.658 | 0.0053 | 0.775 | −0.117 | |
| SrBaFeMn-0.875-0.125-0.5-0.5 | 0.785 | 0.0053 | 0.697 | 0.088 | |
| SrLaFeMg-0.875-0.125-0.75-0.25 | 0.747 | 0.0053 | 0.419 | 0.327 | |
| SrLaFeMg-0.375-0.625-0.5-0.5 | 0.833 | 0.0052 | 0.64 | 0.192 | |
| SrBaFeMn-0.75-0.25-0.625-0.375 | 0.807 | 0.0052 | 0.675 | 0.132 | |
| SrLaFeMn-0.875-0.125-0.5-0.5 | 0.766 | 0.0051 | 0.378 | 0.387 | |
| SrBaFeTi-0.25-0.75-0.875-0.125 | 0.921 | 0.0051 | 0.834 | 0.087 | pure |
| SrCaFeMg-0.75-0.25-0.75-0.25 | 0.632 | 0.0051 | 0.607 | 0.026 | |
| SrBaFeTi-0.625-0.375-0.875-0.125 | 0.822 | 0.0051 | 0.808 | 0.014 | |
| SrCaFeMn-0.875-0.125-0.625-0.375 | 0.7 | 0.0051 | 0.591 | 0.109 | |
| SrFeTi-1-0.75-0.25 | 0.714 | 0.005 | 0.547 | 0.167 | pure |
| SrCaFeMn-0.625-0.375-0.5-0.5 | 0.63 | 0.005 | 0.488 | 0.143 | |
| SrCaFeMn-0.375-0.625-0.625-0.375 | 0.57 | 0.005 | 0.766 | −0.196 | |
| SrLaFeMg-0.75-0.25-0.625-0.375 | 0.724 | 0.005 | 0.535 | 0.189 | |
| SrBaFeMn-0.5-0.5-0.75-0.25 | 0.839 | 0.005 | 0.391 | 0.448 | impure |
| SrLaFeMg-0.625-0.375-0.75-0.25 | 0.772 | 0.005 | 0.641 | 0.132 | |
| SrFeMg-1-0.75-0.25 | 0.676 | 0.005 | 0.301 | 0.375 | |
| SrBaFeMn-0.375-0.625-0.875-0.125 | 0.859 | 0.0049 | 0.756 | 0.103 | impure |
| SrBaFeTi-0.125-0.875-0.875-0.125 | 0.914 | 0.0049 | 0.704 | 0.209 | pure |
| SrCaFeMn-0.625-0.375-0.875-0.125 | 0.615 | 0.0049 | 0.553 | 0.062 | |
| SrBaFeMg-0.875-0.125-0.5-0.5 | 0.656 | 0.0049 | 0.698 | −0.042 | |
| SrBaFeMn-0.5-0.5-0.875-0.125 | 0.821 | 0.0049 | 0.674 | 0.147 | |
| SrCaFeMn-0.875-0.125-0.75-0.25 | 0.67 | 0.0049 | 0.617 | 0.053 | |
| SrBaFeMn-0.5-0.5-0.625-0.375 | 0.818 | 0.0049 | 0.6 | 0.219 | |
| SrBaFeMn-0.5-0.5-0.375-0.625 | 0.813 | 0.0048 | 0.673 | 0.14 | |
| SrCaFeMn-0.625-0.375-0.75-0.25 | 0.607 | 0.0048 | 0.533 | 0.074 | |
| SrLaFeMn-0.875-0.125-0.25-0.75 | 0.719 | 0.0048 | 0.587 | 0.132 | |
| SrCaFeTi-0.875-0.125-0.875-0.125 | 0.657 | 0.0048 | 0.545 | 0.112 | |
| SrBaFeMg-0.25-0.75-0.875-0.125 | 0.85 | 0.0048 | 0.72 | 0.13 | pure |
| SrBaFeMg-0.875-0.125-0.75-0.25 | 0.681 | 0.0048 | 0.496 | 0.185 | |
| SrLaFeMn-0.75-0.25-0.25-0.75 | 0.746 | 0.0048 | 0.545 | 0.201 | |
| SrLaFeMg-0.875-0.125-0.5-0.5 | 0.641 | 0.0048 | 0.589 | 0.053 | |
| SrBaFeMn-0.875-0.125-0.75-0.25 | 0.707 | 0.0047 | 0.603 | 0.105 | |
| SrCaFeTi-0.875-0.125-0.75-0.25 | 0.638 | 0.0047 | 0.73 | −0.093 | |
| SrBaFeMn-0.75-0.25-0.25-0.75 | 0.726 | 0.0047 | 0.866 | −0.14 | impure |
| SrLaFeMg-0.25-0.75-0.375-0.625 | 0.759 | 0.0047 | 0.661 | 0.098 | |
| SrBaFeTi-0.375-0.625-0.875-0.125 | 0.81 | 0.0047 | 0.844 | −0.034 | impure |
| SrBaFeMg-0.375-0.625-0.875-0.125 | 0.793 | 0.0046 | 0.759 | 0.034 | |
| SrCaFeMg-0.875-0.125-0.75-0.25 | 0.602 | 0.0046 | 0.474 | 0.128 | |
| SrBaFeMg-0.875-0.125-0.625-0.375 | 0.632 | 0.0046 | 0.57 | 0.062 | |
| SrBaFeTi-0.75-0.25-0.875-0.125 | 0.709 | 0.0046 | 0.752 | −0.043 | |
| SrBaFeMg-0.5-0.5-0.875-0.125 | 0.75 | 0.0046 | 0.685 | 0.065 | |
| SrBaFeMn-0.375-0.625-0.625-0.375 | 0.794 | 0.0046 | 0.691 | 0.104 | |
| SrCaFeMg-0.625-0.375-0.875-0.125 | 0.55 | 0.0045 | 0.483 | 0.068 | |
| SrFeMn-1-0.5-0.5 | 0.638 | 0.0045 | 0.346 | 0.292 | |
| SrBaFeMn-0.75-0.25-0.375-0.625 | 0.69 | 0.0044 | 0.83 | −0.14 | |
| SrFeMn-1-0.625-0.375 | 0.631 | 0.0044 | 0.322 | 0.309 | |
| SrCaFeMg-0.75-0.25-0.625-0.375 | 0.526 | 0.0044 | 0.553 | −0.027 | |
| SrBaFeMn-0.625-0.375-0.75-0.25 | 0.707 | 0.0044 | 0.682 | 0.025 | |
| SrBaFeTi-0.875-0.125-0.875-0.125 | 0.648 | 0.0044 | 0.607 | 0.041 | |
| SrBaFeMn-0.375-0.625-0.5-0.5 | 0.758 | 0.0044 | 0.695 | 0.063 | |
| SrBaFeMg-0.625-0.375-0.75-0.25 | 0.671 | 0.0043 | 0.601 | 0.069 | |
| SrCaFeMn-0.5-0.5-0.75-0.25 | 0.515 | 0.0043 | 0.479 | 0.036 | |
| SrBaFeMn-0.125-0.875-0.875-0.125 | 0.795 | 0.0043 | 0.683 | 0.112 | |
| SrCaFeMg-0.875-0.125-0.5-0.5 | 0.517 | 0.0042 | 0.244 | 0.274 | |
| SrBaFeTi-0.125-0.875-0.5-0.5 | 0.777 | 0.0042 | 0.62 | 0.156 | |
| BaFeMn-1-0.25-0.75 | 0.815 | 0.0042 | 0.958 | −0.143 | |
| SrLaFeMg-0.125-0.875-0.25-0.75 | 0.696 | 0.0042 | 0.681 | 0.015 | |
| SrCaFeMn-0.5-0.5-0.625-0.375 | 0.504 | 0.0042 | 0.532 | −0.029 | |
| SrCaFeTi-0.75-0.25-0.875-0.125 | 0.548 | 0.0042 | 0.42 | 0.128 | |
| SrBaFeMn-0.625-0.375-0.625-0.375 | 0.678 | 0.0042 | 0.579 | 0.1 | |
| SrBaFeMn-0.75-0.25-0.5-0.5 | 0.651 | 0.0042 | 0.6 | 0.05 | |
| SrCaFeMn-0.625-0.375-0.625-0.375 | 0.522 | 0.0042 | 0.438 | 0.084 | |
| SrFeMg-1-0.625-0.375 | 0.595 | 0.0042 | 0.416 | 0.179 | |
| SrBaFeTi-0.5-0.5-0.625-0.375 | 0.686 | 0.0041 | 0.69 | −0.004 | |
| SrBaFeTi-0.75-0.25-0.75-0.25 | 0.635 | 0.0041 | 0.681 | −0.046 | |
| SrBaFeMn-0.75-0.25-0.75-0.25 | 0.642 | 0.0041 | 0.533 | 0.109 | |
| SrLaFeMg-0.5-0.5-0.625-0.375 | 0.648 | 0.0041 | 0.649 | 0 | |
| SrBaFeMg-0.625-0.375-0.625-0.375 | 0.618 | 0.0041 | 0.515 | 0.103 | |
| SrBaFeMg-0.75-0.25-0.5-0.5 | 0.574 | 0.0041 | 0.651 | −0.077 | |
| SrLaFeMn-0.875-0.125-0.375-0.625 | 0.606 | 0.0041 | 0.505 | 0.101 | |
| SrLaFeMg-0.875-0.125-0.625-0.375 | 0.56 | 0.0041 | 0.5 | 0.059 | |
| SrLaFeMg-0.25-0.75-0.5-0.5 | 0.671 | 0.004 | 0.826 | −0.154 | |
| SrBaFeMn-0.5-0.5-0.5-0.5 | 0.678 | 0.004 | 0.81 | −0.132 | |
| SrBaFeMg-0.125-0.875-0.875-0.125 | 0.737 | 0.004 | 0.712 | 0.025 | |
| SrBaFeMn-0.875-0.125-0.625-0.375 | 0.601 | 0.004 | 0.472 | 0.129 | |
| SrBaFeMn-0.625-0.375-0.5-0.5 | 0.65 | 0.004 | 0.695 | −0.045 | |
| SrBaFeMg-0.625-0.375-0.5-0.5 | 0.589 | 0.004 | 0.757 | −0.168 | |
| SrBaFeTi-0.875-0.125-0.75-0.25 | 0.591 | 0.004 | 0.662 | −0.071 | |
| SrBaFeMn-0.625-0.375-0.375-0.625 | 0.646 | 0.004 | 0.72 | −0.074 | |
| SrCaFeMn-0.5-0.5-0.25-0.75 | 0.476 | 0.004 | 0.521 | −0.045 | |
| SrBaFeTi-0.375-0.625-0.75-0.25 | 0.694 | 0.004 | 0.628 | 0.066 | |
| SrBaFeTi-0.25-0.75-0.75-0.25 | 0.709 | 0.004 | 0.715 | −0.006 | |
| SrLaFeMg-0.75-0.25-0.5-0.5 | 0.557 | 0.004 | 0.525 | 0.031 | |
| SrBaFeMg-0.5-0.5-0.75-0.25 | 0.631 | 0.0039 | 0.787 | −0.156 | |
| SrCaFeMn-0.5-0.5-0.375-0.625 | 0.466 | 0.0039 | 0.415 | 0.051 | |
| SrBaFeMn-0.375-0.625-0.75-0.25 | 0.68 | 0.0039 | 0.622 | 0.059 | |
| SrBaFeTi-0.5-0.5-0.875-0.125 | 0.651 | 0.0039 | 0.722 | −0.071 | |
| SrBaFeMg-0.75-0.25-0.625-0.375 | 0.557 | 0.0039 | 0.586 | −0.029 | |
| SrBaFeMg-0.5-0.5-0.5-0.5 | 0.582 | 0.0038 | 0.753 | −0.171 | |
| SrBaFeMg-0.25-0.75-0.75-0.25 | 0.656 | 0.0038 | 0.756 | −0.1 | |
| SrCaFeMg-0.875-0.125-0.625-0.375 | 0.476 | 0.0038 | 0.62 | −0.145 | |
| SrBaFeMn-0.125-0.875-0.625-0.375 | 0.702 | 0.0038 | 0.75 | −0.048 | |
| SrCaFeMn-0.75-0.25-0.25-0.75 | 0.486 | 0.0037 | 0.484 | 0.002 | |
| SrCaFe-0.25-0.75-1 | 0.396 | 0.0037 | 0.343 | 0.053 | |
| SrCaFeTi-0.5-0.5-0.75-0.25 | 0.431 | 0.0037 | 0.603 | −0.172 | |
| SrBaFeTi-0.625-0.375-0.75-0.25 | 0.585 | 0.0037 | 0.523 | 0.062 | |
| SrCaFeMn-0.5-0.5-0.875-0.125 | 0.436 | 0.0036 | 0.255 | 0.181 | |
| SrBaFeMn-0.375-0.625-0.375-0.625 | 0.625 | 0.0036 | 0.586 | 0.039 | |
| SrCaFeMn-0.875-0.125-0.5-0.5 | 0.492 | 0.0036 | 0.197 | 0.295 | |
| SrBaFeMg-0.25-0.75-0.5-0.5 | 0.591 | 0.0036 | 0.796 | −0.204 | |
| SrCaFeTi-0.125-0.875-0.75-0.25 | 0.358 | 0.0036 | 0.333 | 0.024 | |
| SrLaFeMg-0.375-0.625-0.375-0.625 | 0.553 | 0.0035 | 0.658 | −0.106 | |
| SrBaFeMg-0.375-0.625-0.75-0.25 | 0.583 | 0.0035 | 0.534 | 0.049 | |
| SrFeMn-1-0.125-0.875 | 0.499 | 0.0035 | 0.542 | −0.043 | |
| SrCaFeMn-0.875-0.125-0.25-0.75 | 0.478 | 0.0035 | 0.702 | −0.224 | |
| SrBaFeMn-0.25-0.75-0.75-0.25 | 0.629 | 0.0035 | 0.803 | −0.174 | |
| SrCaFeMg-0.5-0.5-0.75-0.25 | 0.387 | 0.0035 | 0.433 | −0.045 | |
| SrBaFeMn-0.125-0.875-0.5-0.5 | 0.644 | 0.0035 | 0.693 | −0.049 | |
| SrBaFeMg-0.375-0.625-0.625-0.375 | 0.559 | 0.0034 | 0.692 | −0.133 | |
| SrBaFeMn-0.125-0.875-0.75-0.25 | 0.639 | 0.0034 | 0.646 | −0.007 | |
| SrBaFeMg-0.125-0.875-0.5-0.5 | 0.582 | 0.0034 | 0.756 | −0.173 | |
| SrBaFeMg-0.125-0.875-0.75-0.25 | 0.602 | 0.0034 | 0.524 | 0.078 | |
| SrBaFeMn-0.875-0.125-0.25-0.75 | 0.485 | 0.0033 | 0.708 | −0.223 | |
| SrBaFeMn-0.25-0.75-0.5-0.5 | 0.587 | 0.0033 | 0.786 | −0.199 | |
| SrCaFeMn-0.625-0.375-0.25-0.75 | 0.404 | 0.0032 | 0.472 | −0.068 | |
| SrBaFeMn-0.25-0.75-0.125-0.875 | 0.581 | 0.0032 | 0.792 | −0.211 | |
| SrMn-1-1 | 0.452 | 0.0032 | 0.372 | 0.08 | |
| SrBaFeTi-0.125-0.875-0.75-0.25 | 0.583 | 0.0032 | 0.643 | −0.06 | |
| SrCaFeMg-0.625-0.375-0.75-0.25 | 0.371 | 0.0032 | 0.551 | −0.18 | |
| SrBaFeMg-0.25-0.75-0.625-0.375 | 0.53 | 0.0031 | 0.703 | −0.173 | |
| SrLaFeMg-0.5-0.5-0.375-0.625 | 0.467 | 0.0031 | 0.593 | −0.126 | |
| SrLaFeMg-0.75-0.25-0.375-0.625 | 0.424 | 0.0031 | 0.626 | −0.202 | |
| SrCaFeMg-0.5-0.5-0.625-0.375 | 0.321 | 0.003 | 0.432 | −0.112 | |
| SrCaFeMg-0.5-0.5-0.875-0.125 | 0.344 | 0.003 | 0.292 | 0.051 | |
| SrBaFeMg-0.5-0.5-0.625-0.375 | 0.445 | 0.0028 | 0.671 | −0.226 | |
| SrCaFeMn-0.25-0.75-0.875-0.125 | 0.303 | 0.0028 | 0.258 | 0.044 | |
| SrLaFeMn-0.75-0.25-0.125-0.875 | 0.415 | 0.0027 | 0.341 | 0.074 | |
| SrCaFeMg-0.375-0.625-0.75-0.25 | 0.281 | 0.0027 | 0.191 | 0.09 | |
| SrCaFeTi-0.5-0.5-0.875-0.125 | 0.309 | 0.0026 | 0.161 | 0.148 | |
| SrLaFeMg-0.625-0.375-0.375-0.625 | 0.336 | 0.0023 | 0.552 | −0.216 | |
| SrCaFe-0.625-0.375-1 | 0.276 | 0.0022 | 0.378 | −0.102 | |
| SrBaFeMn-0.625-0.375-0.125-0.875 | 0.327 | 0.002 | 0.54 | −0.213 | |
| SrCaFeMg-0.25-0.75-0.875-0.125 | 0.179 | 0.0017 | 0.281 | −0.101 | |
| SrBaFeTi-0.5-0.5-0.75-0.25 | 0.282 | 0.0017 | 0.445 | −0.163 | |
| SrCaFe-0.5-0.5-1 | 0.2 | 0.0017 | 0.112 | 0.088 | |
| SrCaFeMn-0.875-0.125-0.125-0.875 | 0.219 | 0.0016 | 0.349 | −0.13 | impure |
| CaFeMn-1-0.75-0.25 | 0.131 | 0.0014 | 0.213 | −0.082 | |
| SrCaFeMn-0.75-0.25-0.125-0.875 | 0.153 | 0.0012 | 0.386 | −0.233 | |
| SrLaMn-0.875-0.125-1 | 0.168 | 0.0011 | 0.119 | 0.049 | |
| SrCaFeMn-0.5-0.5-0.125-0.875 | 0.13 | 0.0011 | 0.031 | 0.099 | |
| SrLaFeMn-0.875-0.125-0.125-0.875 | 0.137 | 0.0009 | 0.171 | −0.034 | |
| SrCaFeMn-0.5-0.5-0.5-0.5 | 0.036 | 0.0003 | 0.123 | −0.088 | |
| SrCaFeMg-0.125-0.875-0.75-0.25 | 0.025 | 0.0003 | 0.046 | −0.021 | |
| SrLaMn-0.75-0.25-1 | 0.011 | 0.0001 | −0.017 | 0.028 | |
| CaFeMg-1-0.875-0.125 | −0.051 | −0.0006 | −0.473 | 0.422 | |
| SrCaFe-0.125-0.875-1 | −0.06 | −0.0006 | −0.19 | 0.13 | |
| SrCaFeMn-0.125-0.875-0.875-0.125 | −0.213 | −0.0021 | −0.093 | −0.119 | |
| CaFeMn-1-0.875-0.125 | −0.226 | −0.0024 | −0.937 | 0.711 | |
| CaFeMg-1-0.75-0.25 | −0.552 | −0.0063 | −0.715 | 0.163 | |

The thermochemical energy storage of the oxides can also be triggered by CO₂ pressure swing. A CO₂-rich gas stream, such as the flue gas from power plants or other industrial processes, is flowed into the reactor during the heat discharging period. The mixed metal oxides will react with the CO₂ to form the carbonate and release a significant amount of heat at the same time. The O₂ release will offset a certain amount of heat release, but the overall reaction is still highly exothermic. Taking Sr_{0.8}Ba_{0.2}Fe_{0.4}Co_{0.6}O_{3-δ} as an example, the carbonation reaction of perovskite with CO₂ is described as follows:

$${Sr}_{0.8} {Ba}_{0.2} {Fe}_{0.4} {Co}_{0.6} {O}_{3 - δ} + {CO}_{2} = 0.8 {SrCO}_{3} + 0.2 {BaCO}_{3} + 0.2 {Fe}_{2} {O}_{3} + 0.6 CoO + \frac{1 - δ}{2} {O}_{2}$$

During the heat charging mode, high-temperature steam and O₂ flow into the reactor. The carbonate will decompose and absorb a significant amount of heat. At the same time, the perovskite will be regenerated so that the sintering can be avoided. The decarbonation reaction and the regeneration reaction can be described as follows:

$$0.8 {SrCO}_{3} + 0.2 {BaCO}_{3} + 0.2 {Fe}_{2} {O}_{3} + 0.6 CoO + \frac{1 - δ}{2} {O}_{2} = {Sr}_{0.8} {Ba}_{0.2} {Fe}_{0.4} {Co}_{0.6} {O}_{3 - δ} + {CO}_{2}$$

The gas flow downstream contains concentrated CO₂, which is desirable for CO₂ capture and utilization. Based on this reaction, CO₂ can be combined with thermal energy storage.

### Redox Oxygen Capacity and Energy Density Performance

The oxygen capacities under different conditions are summarized in Table.1. Under the redox condition of 400° C./0.2 atm O₂ and 800° C./0.01 atm O₂, the highest oxygen capacity was 2.11 wt. % for Sr_{0.75}Ba_{0.25}Fe_{0.875}Mg_{0.125}O_{3-δ}, while Sr_{0.5}La_{0.5}Fe_{0.125}Mn_{0.85}O_{3-δ} show negligible oxygen release. Ba-doped or Ba/Mg-co-doped SrFeO_{3-δ} exhibited considerable oxygen capacities at low temperatures and high oxygen partial pressures. Compared to SrFeO_{3-δ}, Sr_{0.75}Ba_{0.25}Fe_{0.875}Mg_{0.125}O_{3-δ} and Sr_{0.875}Ba_{0.125}FeO_{3-δ} favored oxygen release at higher oxygen pressure. The oxygen absorption/desorption kinetics also increased with the Ba dopant, which would be beneficial to the power density. However, when Ba doping was larger than 0.375 (e.g., Sr_{0.5}Ba_{0.5}FeO_{3-δ}), phase segregation of BaFeO₃ and SrFeO₃ was observed through XRD. Interestingly, phase segregation at high Ba levels can be inhibited by substituting Fe with small amounts of Mg and Ti in the B-site, e.g., Sr_{0.25}Ba_{0.75}Fe_{0.875}Mg_{0.125}O_{3-δ} and Sr_{0.125}Ba_{0.875}Fe_{0.875}Ti_{0.125}O_{3-δ}. Even though the oxygen capacities were slightly lower, they all demonstrated sufficient oxygen capacity under an isothermal condition at 400° C. even though 0.01 atm O₂ was used as the lower bound for oxygen partial pressure, which is three orders of magnitude higher than typical testing conditions. In general, Ba-based perovskites exhibited superior performance in O₂ redox capacity within the 400-800° C. range, which is highly compatible with steam-based power plants.

SrₓCa₁₋ₓFe_{y}Mn_{1-y}O_{3-δ} perovskites were another group of materials showing promising TCES performance. They exhibited the highest changes in δ owing to their smaller molar masses. Mn-doping tended to increase the temperature window for oxygen release, a considerable amount of oxygen was released in the range of 800-1100° C. Sr_{0.125}Ca_{0.875}Fe_{0.25}Mn_{0.75}O_{3-δ}, Sr_{0.25}Ca_{0.75}Fe_{0.375}Mn_{0.625}O_{3-δ}, and Sr_{0.375}Ca_{0.625}Fe_{0.125}Mn_{0.875}O_{3-δ} all exhibited oxygen releases >2.8 wt % under the redox condition between 400° C./0.2 atm O₂ and 1100° C./Ar. In particular, Sr_{0.375}Ca_{0.625}Fe_{0.125}Mn_{0.875}O_{3-δ} and Sr_{0.125}Ca_{0.875}Fe_{0.25}Mn_{0.75}O_{3-δ} had an oxygen capacity >2.1 wt % even with a redox condition between 400° C./0.2 atm O₂ and 1100° C./0.01 atm O₂. This moderate oxygen atmosphere is helpful for the flexible operation of industrial TCES applications.

TABLE 4
Oxygen Release Capacity of Selected Perovskite Materials at Different Redox Conditions

| | Parameters (wt %) | | | | | | |
|---|---|---|---|---|---|---|---|
| | Isothermal condition | | | | Pressure + temperature swing | | |
| | 400° C. | | 800° C. | | 400-800° C. | | |
| | 0.2-0.01 | 0.2 atm | 0.2-0.01 | 0.2 atm | 0.2 atm | 0.2-0.01 | 0.2 atm |
| Material | atm O₂ | O₂—Ar | atm O₂ | O₂—Ar | O₂ | atm O₂ | O₂—Ar |
| Sr_{0.625}Ba_{0.375}FeO_{3-δ} | 0.44 | 0.91 | 0.51 | 0.85 | 1.34 | 1.85 | 2.19 |
| Sr_{0.75}Ba_{0.25}FeO_{3-δ} | 0.21 | 1.02 | 0.53 | 0.86 | 1.19 | 1.71 | 2.05 |
| Sr_{0.875}Ba_{0.125}Fe_{0.875}Mn_{0.125}O_{3-δ} | 0.28 | 0.60 | 0.44 | 0.81 | 1.19 | 1.64 | 2.00 |
| Sr_{0.75}Ba_{0.25}Fe_{0.875}Mg_{0.125}O_{3-δ} | 0.30 | 0.65 | 0.39 | 0.68 | 1.30 | 1.68 | 1.98 |
| Sr_{0.25}Ba_{0.75}Fe_{0.875}Mg_{0.125}O_{3-δ} | 0.72 | 1.27 | 0.44 | 0.69 | 1.14 | 1.58 | 1.83 |
| Sr_{0.625}Ba_{0.375}Fe_{0.875}Mn_{0.125}O_{3-δ} | 0.14 | 0.76 | 0.30 | 0.59 | 1.02 | 1.32 | 1.61 |
| Sr_{0.125}Ba_{0.875}Fe_{0.875}Ti_{0.125}O_{3-δ} | 0.49 | 0.81 | 0.25 | 0.53 | 1.07 | 1.33 | 1.61 |
| Sr_{0.75}Ba_{0.25}Fe_{0.875}Mn_{0.125}O_{3-δ} | 0.08 | 0.65 | 0.31 | 0.63 | 0.95 | 1.27 | 1.59 |
| Sr_{0.375}Ca_{0.625}Fe_{0.125}Mn_{0.875}O_{3-δ} | 0.08 | 0.36 | 0.38 | 1.23 | 0.30 | 0.67 | 1.52 |
| SrFe_{0.875}Mn_{0.125}O_{3-δ} | 0.12 | 0.41 | 0.29 | 0.62 | 0.84 | 1.13 | 1.46 |
| Sr_{0.25}Ca_{0.75}Fe_{0.75}Mn_{0.25}O_{3-δ} | 0.12 | 0.46 | 0.33 | 1.09 | 0.37 | 0.70 | 1.46 |
| Sr_{0.75}Ca_{0.25}Fe_{0.75}Ti_{0.25}O_{3-δ} | 0.21 | 0.68 | 0.29 | 0.56 | 0.89 | 1.18 | 1.44 |
| Sr_{0.75}La_{0.25}Fe_{0.375}Mn_{0.625}O_{3-δ} | 0.08 | 0.31 | 0.33 | 0.79 | 0.59 | 0.91 | 1.37 |
| Sr_{0.875}Ca_{0.125}Fe_{0.625}Ti_{0.375}O_{3-δ} | 0.28 | 0.55 | 0.39 | 0.63 | 0.72 | 1.1 | 1.35 |
| Sr_{0.25}Ca_{0.75}Fe_{0.375}Mn_{0.625}O_{3-δ} | 0.12 | 0.35 | 0.28 | 0.91 | 0.39 | 0.67 | 1.30 |
| Sr_{0.875}La_{0.125}Fe_{0.75}Mn_{0.25}O_{3-δ} | 0.10 | 0.33 | 0.29 | 0.66 | 0.61 | 0.91 | 1.27 |
| Sr_{0.375}Ca_{0.625}Fe_{0.5}Mn_{0.5}O_{3-δ} | 0.17 | 0.47 | 0.30 | 0.89 | 0.36 | 0.66 | 1.25 |
| Sr_{0.875}La_{0.125}Fe_{0.625}Mn_{0.375}O_{3-δ} | 0.19 | 0.38 | 0.30 | 0.67 | 0.54 | 0.84 | 1.21 |
| Sr_{0.875}Ba_{0.125}Fe_{0.625}Ti_{0.375}O_{3-δ} | 0.19 | 0.37 | 0.26 | 0.48 | 0.70 | 0.97 | 1.19 |
| Sr_{0.875}Ca_{0.125}Fe_{0.875}Mg_{0.125}O_{3-δ} | 0.01 | 0.72 | 0.37 | 0.67 | 0.49 | 0.86 | 1.16 |
| Sr_{0.25}Ba_{0.75}Fe_{0.875}Ti_{0.125}O_{3-δ} | 0.14 | 0.36 | 0.18 | 0.40 | 0.73 | 0.91 | 1.13 |
| Sr_{0.75}Ca_{0.25}Fe_{0.875}Mg_{0.125}O_{3-δ} | 0.01 | 0.68 | 0.35 | 0.64 | 0.46 | 0.81 | 1.10 |
| Sr_{0.125}Ca_{0.875}Fe_{0.75}Mn_{0.25}O_{3-δ} | 0.15 | 0.59 | 0.22 | 0.92 | 0.07 | 0.29 | 0.99 |
| Sr_{0.75}Ba_{0.25}Fe_{0.625}Ti_{0.375}O_{3-δ} | 0.04 | 0.38 | 0.17 | 0.34 | 0.60 | 0.77 | 0.94 |
| Sr_{0.75}Ba_{0.25}Fe_{0.5}Ti_{0.5}O_{3-δ} | 0.17 | 0.34 | 0.18 | 0.35 | 0.56 | 0.74 | 0.9 |
| SrFe_{0.375}Mn_{0.625}O_{3-δ} | 0.04 | 0.40 | 0.09 | 0.64 | 0.16 | 0.25 | 0.79 |
| SrFe_{0.75}Ti_{0.25}O_{3-δ} | 0.01 | 0.28 | 0.22 | 0.44 | 0.36 | 0.58 | 0.79 |
| Sr_{0.25}Ca_{0.75}Fe_{0.625}Ti_{0.375}O_{3-δ} | 0.20 | 0.66 | 0.28 | 0.69 | 0.07 | 0.35 | 0.76 |
| BaFe_{0.625}Mn_{0.375}O_{3-δ} | 0.42 | 0.51 | 0.09 | 0.18 | 0.54 | 0.63 | 0.72 |
| Sr_{0.625}Ca_{0.375}Fe_{0.625}Ti_{0.375}O_{3-δ} | 0.14 | 0.52 | 0.17 | 0.45 | 0.23 | 0.40 | 0.68 |
| Sr_{0.625}Ca_{0.375}Fe_{0.5}Ti_{0.5}O_{3-δ} | 0.10 | 0.35 | 0.10 | 0.24 | 0.44 | 0.54 | 0.68 |
| Sr_{0.25}Ca_{0.75}Fe_{0.75}Mn_{0.25}O_{3-δ} | 0.09 | 0.31 | 0.16 | 0.51 | 0.12 | 0.28 | 0.64 |
| Sr_{0.875}Ca_{0.125}Fe_{0.125}Mn_{0.875}O_{3-δ} | 0.01 | 0.07 | 0.06 | 0.26 | 0.20 | 0.26 | 0.46 |
| Sr_{0.25}Ca_{0.75}Fe_{0.625}Mn_{0.375}O_{3-δ} | 0.06 | 0.23 | 0.11 | 0.34 | 0.11 | 0.22 | 0.45 |
| Sr_{0.125}Ca_{0.875}Fe_{0.25}Ti_{0.75}O_{3-δ} | 0.07 | 0.23 | 0.10 | 0.21 | 0.13 | 0.23 | 0.34 |
| Sr_{0.125}Ca_{0.875}Fe_{0.625}Ti_{0.375}O_{3-δ} | 0.03 | 0.13 | 0.05 | 0.13 | 0.06 | 0.11 | 0.19 |
| CaFeO_{3-δ} | 0.08 | 0.15 | 0.10 | 0.18 | 0.00 | 0.10 | 0.18 |
| BaFe_{0.625}Mn_{0.375}O_{3-δ} | −0.02 | 0.02 | 0.01 | 0.07 | 0.03 | 0.04 | 0.10 |
| Sr_{0.5}La_{0.5}Fe_{0.125}Mn_{0.875}O_{3-δ} | −0.09 | −0.04 | −0.03 | −0.01 | 0.02 | −0.01 | 0.02 |

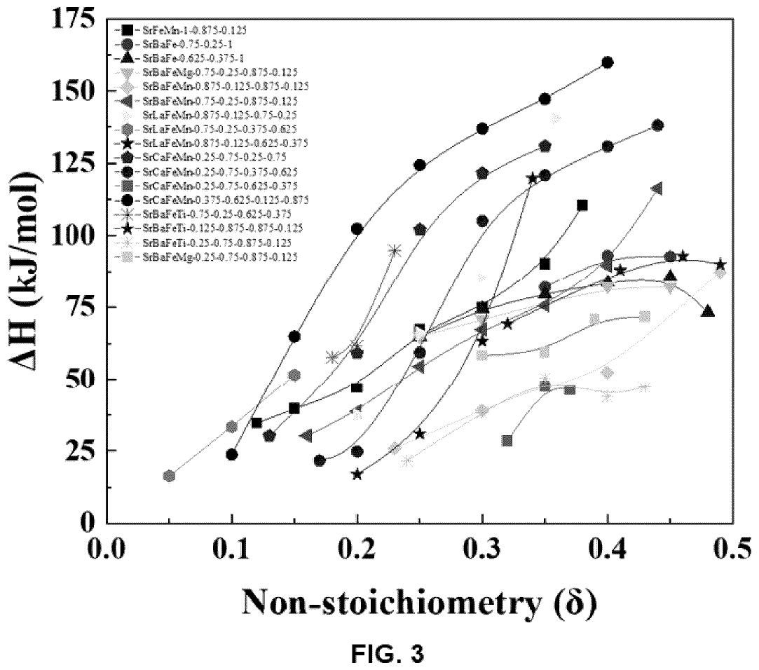

Based on the oxygen capacity under the redox condition between 400° C./0.2 atm O₂ and 1100° C./Ar, 20 materials with oxygen releases >1 wt. % were selected to measure their reaction enthalpies. FIG. 3 summarizes the key results for a few selected material. ΔH of the tested materials varied from 20 to 160 kJ/mol 0, while δ covered nearly the whole range of 0 to 0.5. In general, ΔH increased with the oxygen vacancy, which is consistent with most reported data of SrFeO₃-based perovskite. It is clear that the dopant types and concentrations significantly changed ΔH, but some general trends can be captured from the tested materials. As mentioned above, Ba doping tended to decrease the temperatures for oxygen release, but the corresponding ΔH was also lower compared to La-doped, Ca-doped, or un-doped samples. The ΔH of the Ba-doped SrFeO_{3-δ} samples slightly decreased with the increase in the Ba dopant. This is consistent with Bush et al.'s study on Sr₁₋ₓBaₓFeO_{3-δ} for air separation. Mg-doping stabilized the SrₓBa₁₋ₓFeO_{3-δ} at high-Ba doping conditions and facilitated the oxygen release but negatively affected the ΔH.

The effects of Mn-dopants varied with A-site dopant types. For the Sr—Ca perovskites, Mn doping increased the oxygen release temperature but concurrently led to a higher ΔH. For instance, for the Sr_{0.25}Ca_{0.75}Fe_{y}Mn_{1-y}O_{3-δ} materials and the Sr_{0.375}Ca_{0.625}Fe_{y}Mn_{1-y}O_{3-δ} materials, ΔH significantly increased with the increase in the substitution of Mn in the B-site. However, a small quantity of Mn-doping in Sr_{0.75}Ba_{0.25}FeO_{3-δ} significantly affected ΔH as well as the oxygen release performance. Among all the tested materials, Sr_{0.125}Ca_{0.575}Fe_{0.25}Mn_{0.75}O_{3-δ} displayed the highest ΔH of 160 kJ/mol 0 with Ab of 0.3 under a redox condition between 400° C./0.2 atm O₂ and 1100° C./Ar.

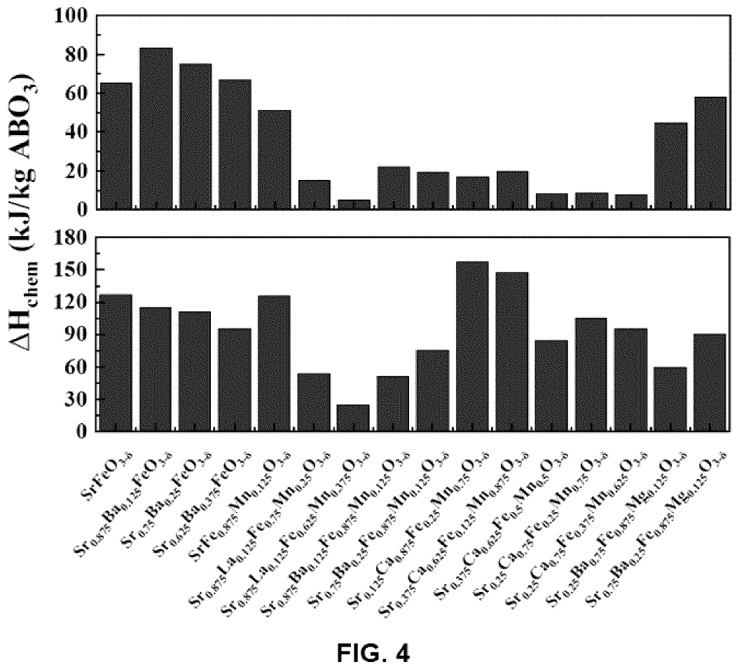

The chemical energy storage densities (ΔH_{chem}) of the screened materials are summarized in FIG. 4. Air can easily trigger the redox reaction of Ba-doped samples. A higher temperature or a lower oxygen partial pressure only leads to a minor increase in ΔH_{chem}, especially for Sr_{0.25}Ba_{0.75}Fe_{0.875}Mg_{0.125}O_{3-δ}. Sr_{0.575}Ba_{0.125}FeO_{3-δ} exhibited the largest ΔH_{chem} of 83 kJ/kg ABO₃ under an isobaric air condition between 400° C. and 800° C. The ability to operate isobarically in air, as opposed to under large oxygen partial pressure swings, would greatly simplify the system design and operations. In contrast, SrₓCa₁₋ₓFe_{y}Mn_{1-y}O_{3-δ} barely released O₂ and absorbed heat at low temperatures, but ΔH_{chem} was significantly improved when the temperature was above 800° C. Sr_{0.125}Ca_{0.575}Fe_{0.25}Mn_{0.75}O_{3-δ} achieved a ΔH_{chem} of 157 kJ/kg ABO₃ under a redox condition between 400° C./0.2 atm O₂ and 1100° C./0.01 atm O₂ and a ΔH_{chem} of 285 kJ/kg ABO₃ under a redox condition between 400° C./0.2 atm O₂ and 1100° C./Ar. Based on an estimated heat capacity of 0.87 kJ/(kg-K), the total energy storage capacities under the two aforementioned conditions are 766 kJ/kg ABO₃ and 894 kJ/kg ABO₃, respectively.

### Assessment of the Model Effectiveness

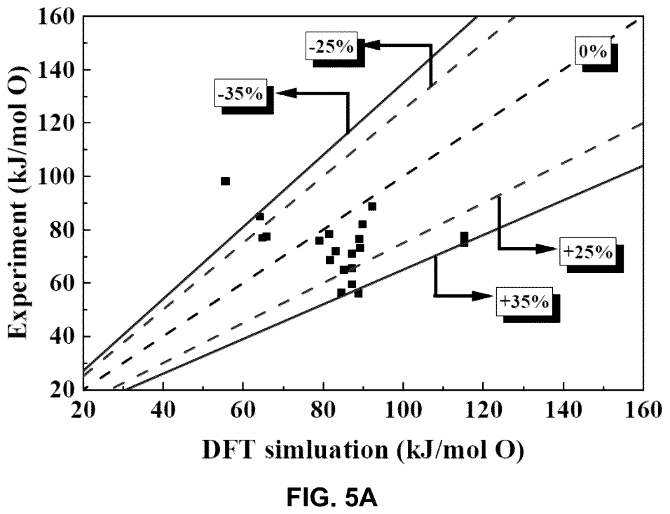

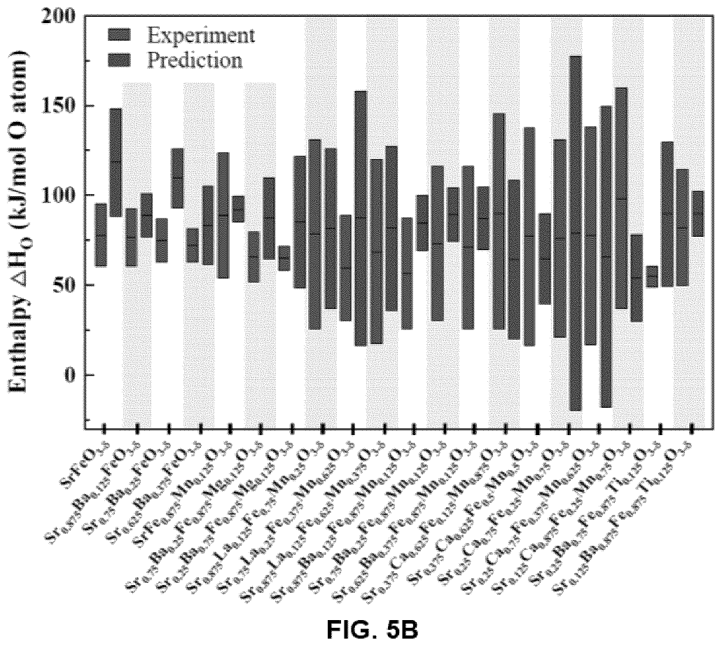

As shown in FIG. 5A, all the samples with appreciable oxygen release showed consistency between experimental measurement and DFT prediction in terms of ΔH, with an average standard deviation of 25.4%. 65% of the data fell within +25%, and 90% of the data fell within ±35%. The ΔH and ΔG are closely related. This is understandable since misprediction of ΔH will likely lead to misprediction of ΔG. Therefore, a simple screening experiment on oxygen capacity, which would rule out most samples with mispredicted ΔG, can substantially increase the accuracy of the DFT prediction. Sr_{0.125}Ca_{0.575}Fe_{0.25}Mn_{0.75}O_{3-δ} showed significant deviation, which is likely to be due to the simplified assumptions adopted for the high throughput computation: DFT calculation started from a cubic SrFeO₃ structure without structural relaxation to maintain computationally efficiency, but Sr_{0.125}Ca_{0.575}Fe_{0.25}Mn_{0.75}O_{3-δ} was orthorhombic based on XRD. FIG. 5B compares the range of the computed ΔH with the measured ΔH. A range was provided since it changes with oxygen non-stoichiometry. For the measured ΔH, the range covered the maximum and minimum ΔH obtained experimentally. The range of the DFT predicted ΔH included ΔH_{δ=0-0.125} and ΔH_{δ=0.125-0.25}. For most materials with sufficient oxygen capacities, the DFT predicted ΔH largely overlapped with the experimental measurements.

### Improved Criteria and Approaches for TCES Optimization

Although the initial screening criteria were sufficient for predicting the ΔH, they led to non-negligible deviation in predicting oxygen capacities. Based upon the experimental data, alternative screening criteria were tested to improve the effectiveness in predicting the oxygen capacity of perovskite oxides. Due to the limit to the supercell size, DFT calculations have limited resolutions for δ change. In the current calculation, the minimum δ change is 0.125. Therefore, the experimentally measured oxygen capacity was correlated with the DFT calculated ΔG at different δ variation ranges to determine the most effective descriptor for the oxygen capacity. Correlation coefficients, defined in Eq.(1), were used to describe the relationship between oxygen capacity and ΔG within different δ ranges.

$$Correl ( Δ G , {n}_{oc} ) = \frac{{\sum }_{i = 1}^{N} ( Δ {G}_{i} - Δ \overline{G} ) ( {n}_{oc , i} - {\overline{n}}_{oc , i} )}{{\sum }_{i = 1}^{N} {( Δ {G}_{i} - Δ \overline{G} )}^{2} {\sum }_{i = 1}^{N} {( {n}_{oc , i} - {\overline{n}}_{oc , i} )}^{2}} \qquad Eq . ( 2 )$$

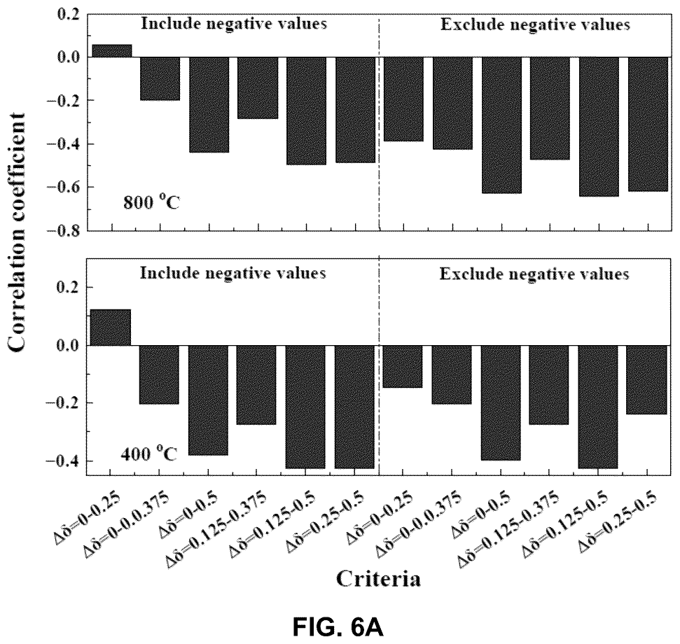

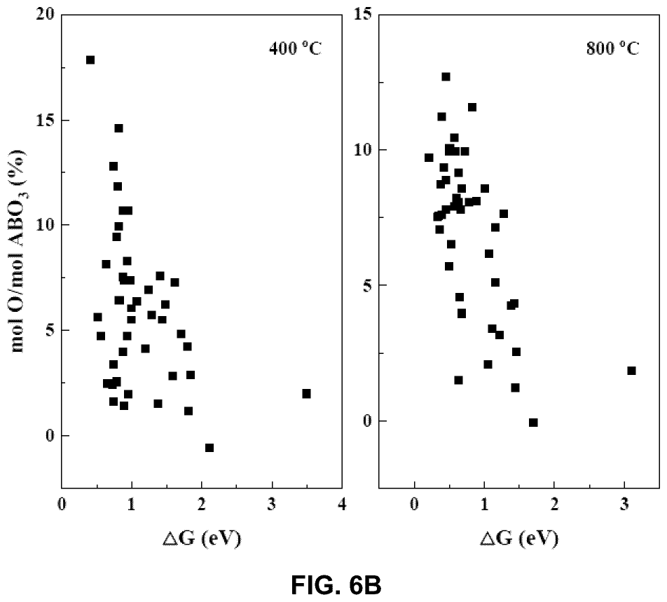

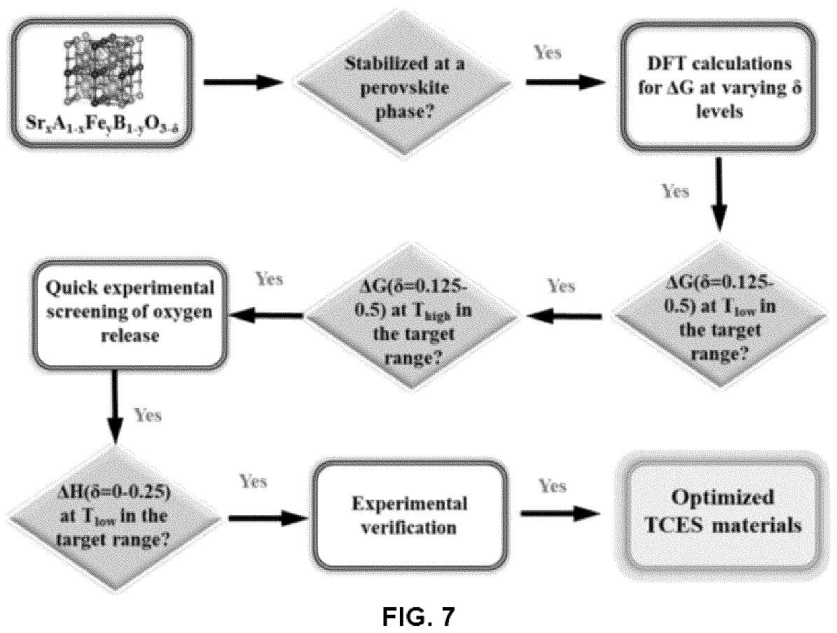

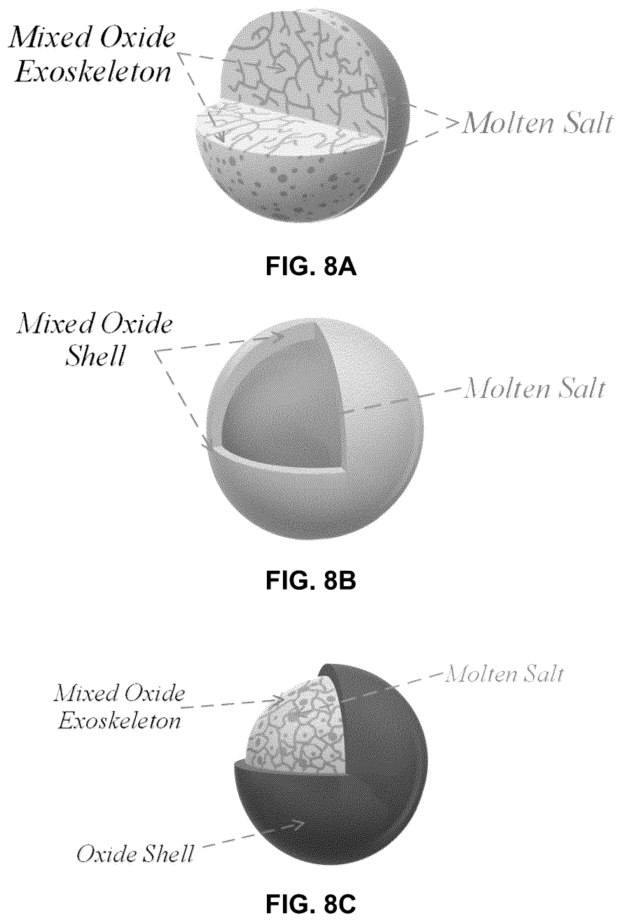

A smaller but non-negative ΔG indicates the thermodynamic favorability of oxygen release from the perovskite. Therefore, oxygen capacity and ΔG should present a negative correlation. Since some DFT calculated ΔG were less than zero and are likely to be inaccurate, the correlation coefficients were also calculated by resetting the negative ΔG to 0. The oxygen capacities under the isothermal redox condition between 0.2 atm O₂ and Ar were used for the calculation. As shown in FIG. 6A, the selection of ΔG within different δ ranges significantly affects the correlation factor. The best prediction was obtained using the non-negative ΔG within the range of 0.125-0.5, which was also consistent with the typical operating δ range of the tested samples between 0.1-0.45. The correlation coefficient was around −0.64 at 800° C., demonstrating a moderately negative correlation which would be highly useful for screening purposes. The correlation was less significant at 400° C., which may have resulted from the kinetic limitation of some perovskite materials. The relationship between ΔG and oxygen capacity using the non-negative ΔG within the range of 0.125-0.5 is shown in FIG. 6B. Based on the aforementioned discussion, a flowchart for high throughput screening of perovskite oxides for TCES is proposed in FIG. 7. It is anticipated that these improved screening criteria would be very helpful for optimizing perovskites for TCES applications.

### CONCLUSIONS

The current study reports an effective high-throughput combinatorial approach for accelerated development and optimization of perovskite oxides for thermochemical energy storage. Based on Density Functional Theory (DFT) calculation results of more than two thousand A-site and/or B-site substituted SrFeO_{3-δ} perovskites at various oxygen non-stoichiometry levels (δ), 61 promising TCES candidates were selected and prepared. Nearly all the samples formed perovskite phases as their main compositions. Of these, 45 samples showed negligible phase impurities and were thoroughly investigated experimentally, including detailed measurements of redox thermodynamic parameters of 20 samples. Many of these samples showed promising TCES properties. Sr_{0.875}Ba_{0.125}FeO_{3-δ} exhibited a chemical energy storage density of 85 kJ/kg ABO₃ under an isobaric air condition between 400° C. and 800° C., and Sr_{0.125}Ca_{0.875}Fe_{0.25}Mn_{0.75}O_{3-δ} achieved an energy density of 157 kJ/kg ABO₃ under a temperature and oxygen partial pressure swing between 400° C./0.2 atm O₂ and 1100° C./0.01 atm O₂. The experimental results supported the effectiveness of the high-throughput predictions for oxygen capacity and standard oxidation enthalpy. An improved set of screening criteria was also developed based on the experimental and DFT results. This improved approach, with an average deviation of 25.4% for predicting the standard oxidation enthalpy and a correlation coefficient of 0.64 for predicting the oxygen capacity, would be highly useful for accelerated development of redox-active perovskite oxides.

### Example 3: Materials and Methods

### DFT Calculations

First-principles DFT simulations were executed using the Vienna ab initio Simulation package (VASP) software. Here the frozen-core all-electron projector augmented wave (PAW) model and Perdew-Burke-Ernzerhof (PBE) functional were utilized. The energy cutoff was set to 450 eV, and the force and energy converged with the criteria of 0.01 eV Å⁻¹ and 10⁻⁵ eV, respectively. Gaussian smearing was employed with a width of 0.1 eV for optimization simulation. 1×1×1 and 1×2×2 k-points were used for the 2×2×2 SrₓA₁₋ₓFe_{y}B_{1-y}O_{3-δ} perovskite supercells and brownmillerite structures, respectively. Based on previous studies, DFT+U method was utilized for d orbitals of Fe, Co, Cu, Mn, Ni, and Ti with U_{eff}=4, 3.4, 4, 3.9, 6, and 3, respectively. Only FM phase magnetic ordering was considered for all the doped structures owing to the negligible effect of magnetic ordering on oxygen vacancy formation and migration. The initial spin moment for Fe, Co, Mn, Ni were set to 4, 5, 5, 5, respectively.

A Monte Carlo special quasi-random structures (MCSQS) method was applied to determine the positions of all A- and B-site dopants and oxygen vacancies to approach randomly disordered structures. The zero-point energy (ZPE) was calculated using the Phonopy code. For an optimized SrₓA₁₋ₓFe_{y}B_{1-y}O_{3-δ} crystal structure, its dynamical matrix of force constants was obtained by using the forces from DFT calculations on a 2×2×2 supercell. The enthalpy of O₂ was computed using the CBS-QB3 method in Gaussian 16. A more detailed description of the simulation approach can be found in a previous publication.

Given an increment of 0.125 for both dopant fraction and nonstoichiometry, 2401 perovskite models and 9604 different conditions were constructed, including various A-site cations (Ca, K, Y, Ba, La or Sm) and/or B-site cations (Co, Cu, Mn, Mg, Ni or Ti). Some unstable perovskite structures were excluded by the preliminary screening with two criteria. Firstly, the compositions should be charge neutral, leading to the removal of 168 materials from the screening list. Then, a modified tolerance factor was used to further eliminate high-distortion candidates, leaving 2003 materials for high-throughput calculations of ΔG, ΔH, and ΔS.

### Material Preparation and Characterization

All the perovskite oxides were synthesized using a solid-state method. In a typical synthesis of SrₓBa₁₋ₓFe_{y}Mn_{1-y}O_{3-δ}, stoichiometric amounts of SrCO₃, BaO, Fe₂O₃ and MnO₂ were weighed and put in a 5 mL PTFE vial. Then, 2 mm ZrO₂ beads were added into the vial with a mass ratio of 5:1. 2 mL ethanol (>99 vol % purity) was further added to the mixture to prevent powders from sticking to the vial walls. Four vials with four different materials were housed in a stainless-steel sample jar and then balled milled with 1200 RPM for 3 h or 24 h. Based on the XRD patterns, excessive ball-milling time will cause minor impurities in some materials. The resulting wet mixture in each vial was dried at 95° C. for 0.5 h and 130° C. for 15 min to remove ethanol. The powder mixture was separated from ZrO₂ beads and then fired at 1000° C. in a muffle furnace for 10 h to obtain the perovskite structure. The heating and cooling rates were all set to be 3° C./min. Finally, the perovskite samples were sieved to two desired particle size ranges, i.e., 180-250 μm for oxygen release experiments and 0-180 μm for XRD and reaction enthalpy experiments. 61 different materials were synthesized in this study. Precursors used were SrCO₃ (>99.9%), CaCO₃ (>99.9%), BaO (>98%), La₂O₃ (>99%), Fe₂O₃ (>99%), MnO₂ (>99%), TiO₂ (>99%) and MgO (>99%).

Crystal structures of the samples were determined on an Empyrean PANalytical XRD with Cu-Kα radiation (λ=1.5406 Å) operating at 45 kV and 40 mA. The scan was conducted from 2θ of 15° to 80° with a step size of 0.0262° and a hold time of 0.2 s for each step. The XRD phases were identified using Highscore Plus software. 45 samples were pure perovskite phases or contained negligibly small phase impurities, but the rest of the 16 samples contained notable impurities.

### Evaluation of the Redox Properties

Two types of experiments were carried out in a thermogravimetric analyzer (TGA, TA-Instrument, SDT Q650). The oxygen capacity experiments were used as the first-step screening for the above-mentioned 40 samples. In a typical experiment, 40-50 mg samples with a particle size of 180-250 μm were loaded into an Al₂O₃ crucible with a 6.5 mm I.D. and then placed in the TGA. The total flow rate was maintained at 200 mL/min, and three oxygen concentrations were tested, i.e., 0.2 atm, 0.01 atm, and Ar (Airgas UHP 5.0 grade). The oxygen concentration was varied by mixing pure oxygen (Airgas extra dry grade O₂) with Ar. The oxygen partial pressure in the Ar flow, which was approximately 5×10⁵ atm, was measured by an oxygen analyzer (Setnag). The sample was increased from room temperature to 180° C. under a 0.2 atm O₂ atmosphere and then was held for 10 min to eliminate moisture. After that, the temperature was ramped to 700° C. and followed by a 10 min isothermal step as a pretreatment. Then, the temperature was decreased to 400° C. and held for 15 min to obtain the first particle weight mi. Another two points were measured at 800° C. and 1100° C., respectively. Afterward, the temperature was ramped back to 400° C., and the oxygen concentration was changed to 1%. The next cycle of the temperature test was started using the same program. After measuring the particle weights at different temperatures and oxygen concentrations, oxygen capacities were obtained under different conditions. The oxygen release kinetics of the Ba-doped or Ba/Mg co-doped SrFeO₃ were also tested.

Twenty samples with an oxygen capacity >1 wt. % were then tested to obtain the oxygen nonstoichiometry and reduction enthalpy. In a typical experiment, ˜30 mg samples with a particle size <180 μm were tested in the TGA. The total flow rate was also maintained at 200 ml/min, and seven different oxygen concentrations were tested, i.e., 0.8, 0.2, 0.05, 0.01, 0.003, 0.0005 atm O₂, and Ar. The 0.003 atm and 0.0005 atm oxygen concentrations were realized by mixing 1.048 vol % O₂ calibration gas (balance Ar) with pure Ar. The temperature was first increased to 1100° C. under the 80% O₂ atmosphere and then held for a specific time until the particle weight change reached equilibrium. The temperature was then sequentially decreased in a stepwise mode by 400° C. with an increment of 100° C. Afterward, the temperature was ramped back to 1100° C., and then the gas atmosphere was switched to 20% O₂. The next cycle of the temperature test was started under a different oxygen concentration using the same program.

### Example 4: Synthesis and Characterization of Composite Materials

A Ca₂AlMnO₅/ binary chloride (CaCl₂/NaCl) composite material was prepared by the following procedures. Ca₂AlMnO₅ was first synthesized via a modified Pechini method and then was balled mill with CaCl₂ and ZrO₂ beads. The resulting powder mixtures were rinsed with ethanol to remove CaCl₂. Afterward, the remaining wet particles were dried in the air to obtain the high-porosity Ca₂AlMnO₅. CaCl₂ and NaCl powders were mixed with a molar ratio of 52:48 and then calcined above the melting point (˜500° C.) to form the binary chloride molten salts. High-porosity Ca₂AlMnO₅ and molten salt powders were mixed with a specific mass ratio and then calcined at 550° C. to form the composite material.

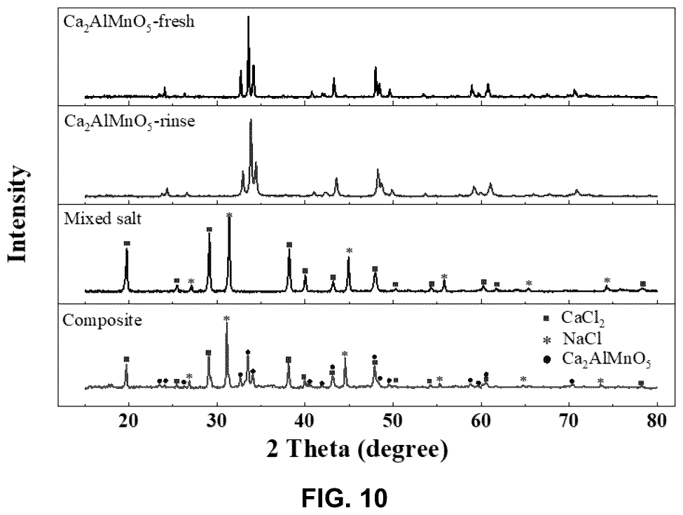

The BET results revealed that the BJH pore volume increased from 0.0002 to 0.14 cm³/g after the ball milling step. As shown in FIG. 10, the high-porosity Ca₂AlMnO₅ has the same XRD pattern as the fresh Ca₂AlMnO₅, verifying the phase stability during the process of increasing porosity. No new peaks were observed in the composite material, also demonstrating good compatibility between the redox oxide and the molten salt.

Other perovskite/metal oxides and eutectic salt mixtures were prepared by mixing in a mortar. A small portion of the particles was separated for TGA experiments, and the rest of the powders were pelletized in a 6 mm I.D. pellet dies at 10 mPa for 3 min with a hydraulic press. This was followed by heating up to 50° C. above the melting points of the salts in a muffle furnace. This step was to ensure the uniform mixing of the salt and perovskite within the pellets by melting the salt. The pellets were heated up by first the ramping rate 3° C./min and then 1° C./min during the last 150° C. to reach a temperature 50° C. above the melting point of the salt mixture, which was kept for 1 hour. This was followed by cooling it down to room temperature. After this step, the pellets were crashed into fine particles for XRD analysis.

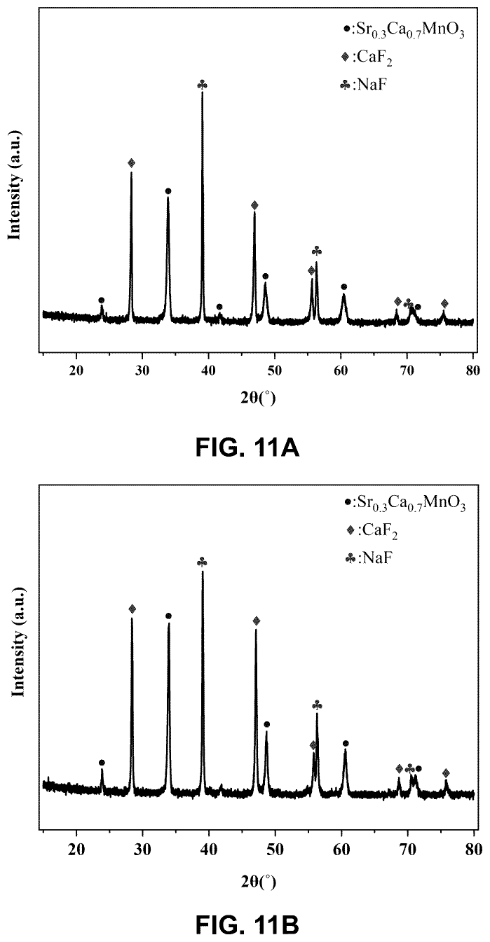

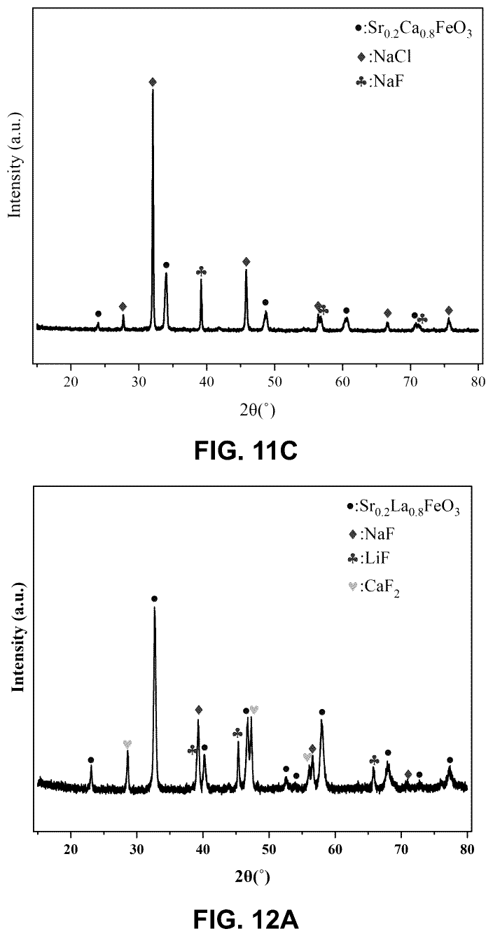

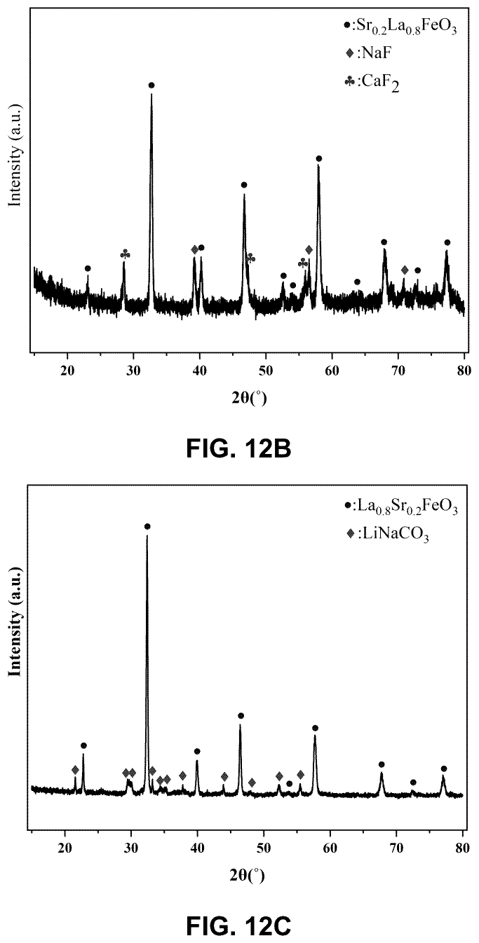

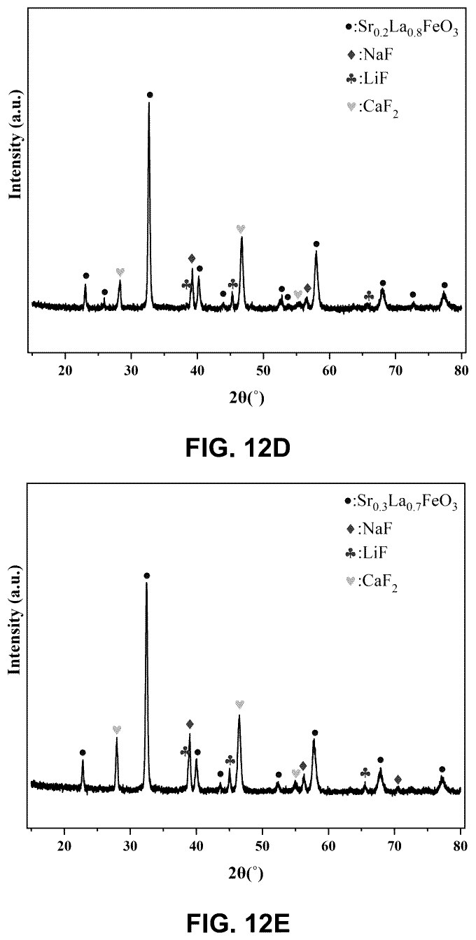

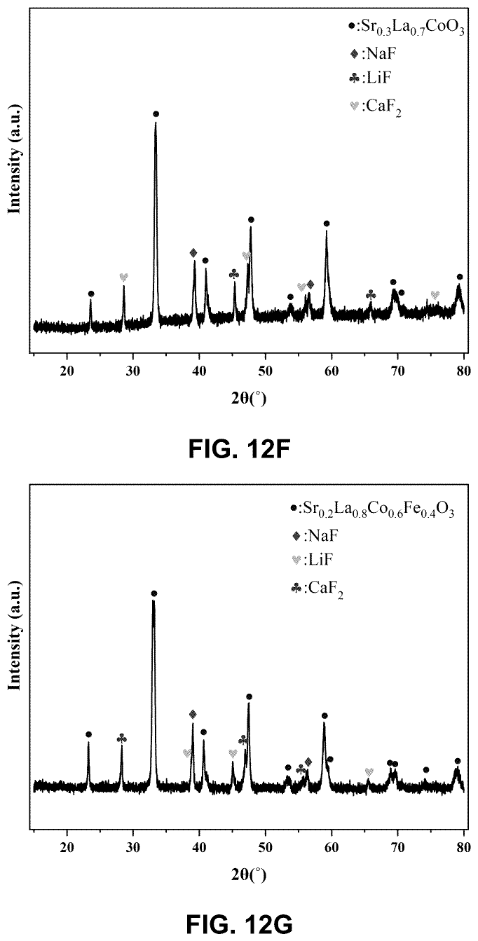

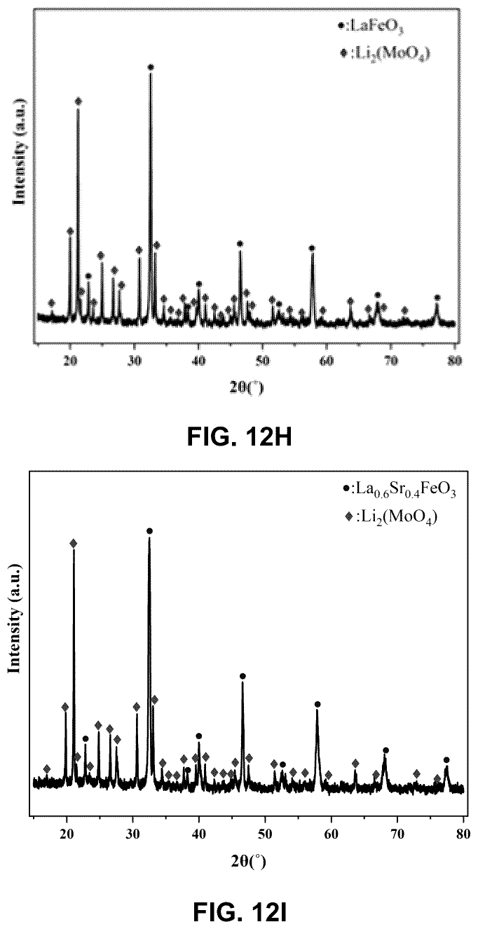

The compatibility results based on the XRD patters were summarized in Table 5. 13 composite materials were found to be compatible among the 26 samples screened. The XRD patterns of the compatible samples were presented in FIGS. 11A-12I. The Ca- and Ba-based oxides were found to be less likely to react with NaF, CaF₂, and NaCl. When there is LiF or MgF₂ in the salt mixtures, mostly the B-site of the perovskite oxides forms new oxide phases with Li, Mg, and Na. Additionally, all cations of SBF and SF created new fluoride salts (SrF₂, BaF₂ . . . ) by breaking the eutectic phase of the salt mixture. On the other hand, La-based oxides were revealed to be more stable structures as they had less tendency to react with salt mixtures in general. These results suggested that increasing Sr in the A-site reduced the stability of the oxide structure. Thus, lower Sr in A-site ensured a compatible composite structure with LiF—NaF—CaF₂ and MgF₂—NaF—CaF₂ whereas SrFeO₃-s and Sr_{0.75}Ba_{0.25}FeO₃—S failed to form a compatible structure with these salts. This phenomenon was also observed for La_{0.7}Sr_{0.3}Co_{0.9}Mn_{0.1}O_{3-δ} and La_{0.3}Sr_{0.7}Co_{0.9}Mn_{0.03}; the former formed a compatible composite material with LiF—NaF—CaF₂ while the latter could not. A similar case that supports the high stability of La-based perovskite oxides was observed for Li₂CO₃—Na₂CO₃ and Li₂MoO₄. The carbonate salt formed a compatible composite with a La-based material while a reaction with a Ba-based oxide occurred, causing incompatibility.

TABLE 5
Compatibility of Metal Oxides and Eutectic Salt Mixtures

| Salt Mixture | | |
|---|---|---|
| (Weight Ratio) | Perovskite | Compatibility |
| Li₂CO₃—Na₂CO₃ | Sr_{0.875}Ba_{0.125}FeO_{3-δ} | Incompatible |
| (0.44:0.56) | La_{0.8}Sr_{0.2}FeO_{3-δ} | Compatible |
| LiF—NaF—CaF₂ | Ca₂AlMnO₅ | Incompatible |
| (0.2-0.35-0.45) | La_{0.8}Sr_{0.2}FeO_{3-δ} | Compatible |
| LiF—NaF—CaF₂ | La_{0.8}Sr_{0.2}FeO_{3-δ} | Compatible |
| (0.35-0.38-0.26) | La_{0.3}Sr_{0.7}Co_{0.9}Mn_{0.1}O_{3-δ} | Incompatible |
| | Sr_{0.05}Ca_{0.95}Mn_{0.95}Co_{0.05}O_{3-δ} | Incompatible |
| | Sr_{0.05}Ca_{0.95}Mn_{0.9}Co_{0.1}O_{3-δ} | Incompatible |
| | La_{0.7}Sr_{0.3}FeO_{3-δ} | Compatible |
| | La_{0.6}Sr_{0.4}FeO_{3-δ} | Compatible |
| | La_{0.7}Sr_{0.3}Co_{0.9}Mn_{0.1}O_{3-δ} | Compatible |
| | La_{0.8}Sr_{0.2}Co_{0.8}Fe_{0.2}O_{3-δ} | Compatible |
| | SrFeO_{3-δ} | Incompatible |
| | Sr_{0.75}Ba_{0.25}FeO_{3-δ} | Incompatible |
| NaF—CaF₂ | Sr_{0.75}Ca_{0.25}Fe_{0.25}Mn_{0.75}O_{3-δ} | Compatible |
| (0.53:0.47) | Sr_{0.125}Ca_{0.875}Fe_{0.25}Mn_{0.75}O_{3-δ} | Compatible |
| MgF₂—NaF—CaF₂ | Sr_{0.75}Ca_{0.25}Fe_{0.25}Mn_{0.75}O_{3-δ} | Incompatible |
| (0.14-0.52-0.34) | La_{0.8}Sr_{0.2}FeO_{3-δ} | Compatible |
| NaF—NaCl | Sr_{0.125}Ca_{0.875}Fe_{0.25}Mn_{0.75}O_{3-δ} | Compatible |
| (0.34:0.64) | | |
| NaF—KF | Sr_{0.125}Ca_{0.875}Fe_{0.25}Mn_{0.75}O_{3-δ} | Incompatible |
| (0.33-0.67) | Ca₂AlMnO₅ | Incompatible |
| LiF—CaF₂ | Sr_{0.75}Ca_{0.25}Fe_{0.25}Mn_{0.75}O_{3-δ} | Incompatible |
| (0.54-0.46) | | |
| LiF—NaF | SrFeO_{3-δ} | Incompatible |
| | Sr_{0.875}Ba_{0.125}FeO_{3-δ} | Incompatible |
| Li₂MoO₄ | La_{0.8}Sr_{0.2}FeO_{3-δ} | Compatible |
| | La_{0.6}Sr_{0.4}FeO_{3-δ} | Compatible |

### Performance of Composite Materials

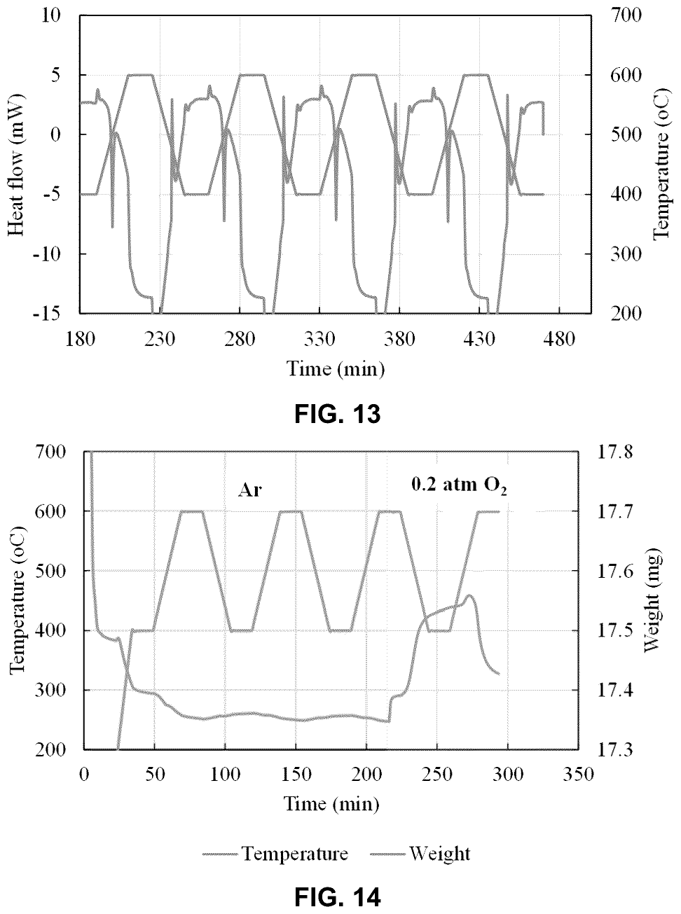

The performance of the composite material was tested in a thermogravimetric analyzer (TGA) under a cyclic operation between 400˜600° C. The latent heat of the molten salt was obtained via a differential scanning calorimeter (DSC) method. The heat flow was first calibrated using a sapphire with a determined heat capacity. As shown in FIG. 13, the heat peaks at around 500° C. corresponded to the solidification or melting of molten salt. The calculated heat release (or heat release) was about 100 kJ/kg_{OMS}. The redox performance of OMS composite material is shown in FIG. 14. The samples were exposed to pure Ar at 600° C. and then switched to 0.2 atm O₂ (Ar balance). The Ca₂AlMnO_{5+δ} absorbed oxygen and released chemical heat during the cooling step. Based on a previous study, the standard oxidation enthalpy is about 150 kJ/mol O₂ within a b range of 0.1-0.4. As such, the corresponding chemical heat is about 54 kJ/kg_{OMS}. The contributions of the sensible heats released from the oxide and molten salt were 85 kJ/kg_{OMS} and 100 kJ/kg_{OMS}, respectively. The total energy storage density of OMS composite material was 339 kJ/kg_{OMS} within the operating temperature window of 400˜600° C.

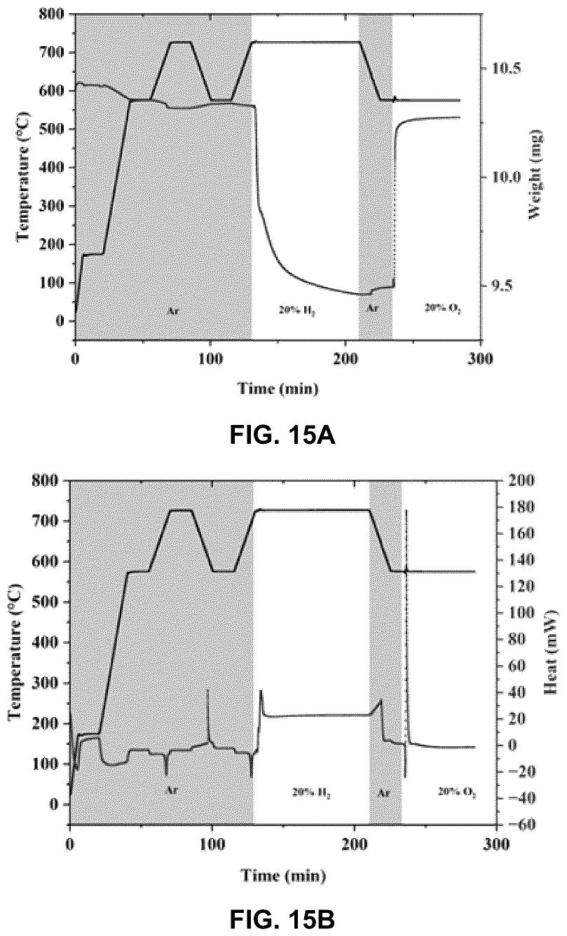

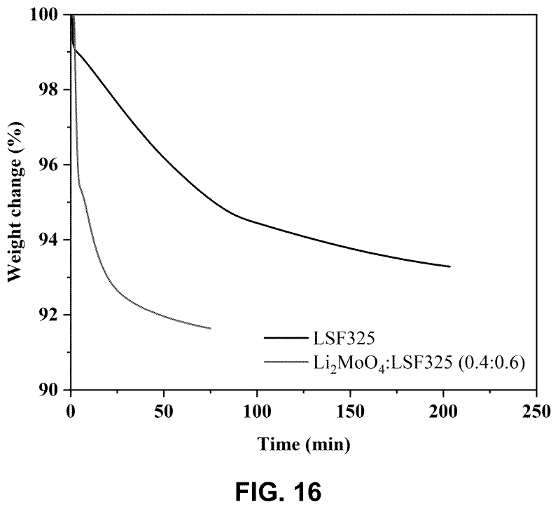

The exhaust gas emitted by furnaces in chemical industries carries substantial waste heat in the form of a reducing gas composition. This composition, often rich in reducing agents like H₂ and CO, holds valuable potential for utilization in thermochemical energy storage applications. By harnessing this waste heat and incorporating it into thermochemical energy storage systems, industries have the opportunity to boost their energy efficiency. Therefore, an experiment under a reducing gas atmosphere was performed to achieve high thermochemical energy through the reduction of perovskite in the composite materials. Among the tested materials with La-based perovskite oxides, La_{0.6}Sr_{0.4}FeO_{3-δ} was the only one that showed a redox capacity in the regarding operating conditions (575-725° C.). Therefore, La_{0.6}Sr_{0.4}FeO_{3-δ}:Li₂MoO₄ was selected with the weight ratio of 0.6:0.4 as a potential candidate for this experiment. After the sample was completely reduced under 20% H₂, it was exposed to 20% O₂ for reoxidation. The thermochemical energy storage from the peak during oxidation was determined as the oxidation occurs suddenly, so the amount of released heat can be found from the DSC method. The plots related to these measurements are presented in FIGS. 15A-15B and the summary of the results can be found in Table 6. For the composite material of La_{0.6}Sr_{0.4}FeO₃-6:Li₂MoO₄, thermochemical energy as high as 852 kJ/kg was achieved. The separate measurements of La_{0.6}Sr_{0.4}FeO₃-s and Li₂MoO₄ proved that the oxidation of Mo salt also has a contribution to thermochemical energy of 852 kJ/kg. A close weight gain and weight loss were recorded for the composite material, which indicates that oxidation and reduction reactions were reversible. Another benefit of mixing La_{0.6}Sr_{0.4}FeO_{3-δ} with Li₂MoO₄ was the faster weight loss under 20% H₂. As shown in FIG. 16, it was found that adding Li₂MoO₄ significantly decreased the time to complete reduction. Therefore, La_{0.6}Sr_{0.4}FeO_{3-δ}:Li₂MoO₄ was found to be a promising composite material to recover industrial waste heat in the form of reducing gaseous.

TABLE 6
Heat Flow (mW) and Weight Change Results of La_{0.6}Sr_{0.4}FeO_{3-δ},
Li₂MoO₄, and La_{0.6}Sr_{0.4}FeO_{3-δ}:Li₂MoO₄(0.6:0.4)
via TGA Experiments

| | Weight | Weight | Oxidation |
|---|---|---|---|
| Material (Oxide:Salt Wt. | Loss | Loss | enthalpy |
| Ratio) | (wt %) | (wt %) | (kJ/kg) |
| La_{0.6}Sr_{0.4}FeO_{3-δ} | 11.98 | 11.05 | 852 |
| Li₂MoO₄ | 7.43 | 4.20 | 619 |
| La_{0.6}Sr_{0.4}FeO_{3-δ}:Li₂MoO₄(0.6:0.4) | 7.85 | 7.51 | 887 |

### Long-Term Stability

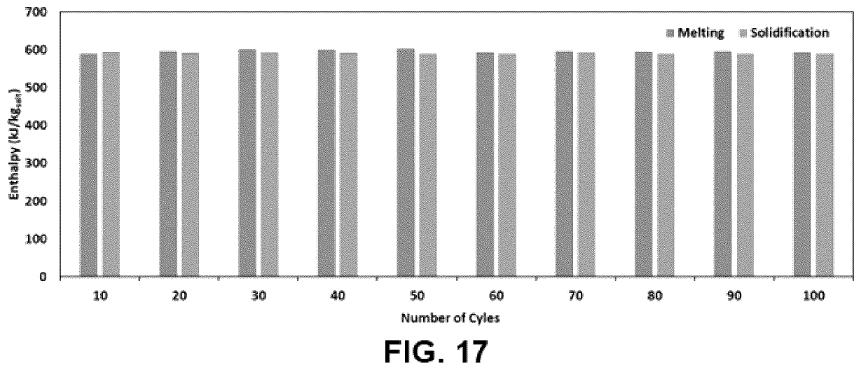

Long term stability test was performed for the sample of La_{0.5}Sr_{0.2}FeO_{3-δ}:LiF—NaF—CaF₂ as it was one of the most promising ones. The sample was operated during 100 redox cycles under the conditions of 510/20% O₂-660° C./Ar. The results of 100 cycles was summarized in FIG. 17. The composite material of La_{0.5}Sr_{0.2}FeO₃-s and NaF—CaF₂—LiF demonstrated outstanding stability for 100 cycles/hours. Both melting enthalpy and melting/solidification temperature were almost the same after 100 cycles. The total weight loss through 100 cycles was only 1.3 wt %. No O₂ release/uptake was observed, so there was no contribution of thermochemical energy to the overall energy density. Heat capacity of the NaF—CaF₂—LiF salt was determined as 1.15 kJ/kg. ° C. based on the ideal mixture assumption. The total energy density for the composite material becomes ˜505 kJ/kg by using the average heat of fusion value.

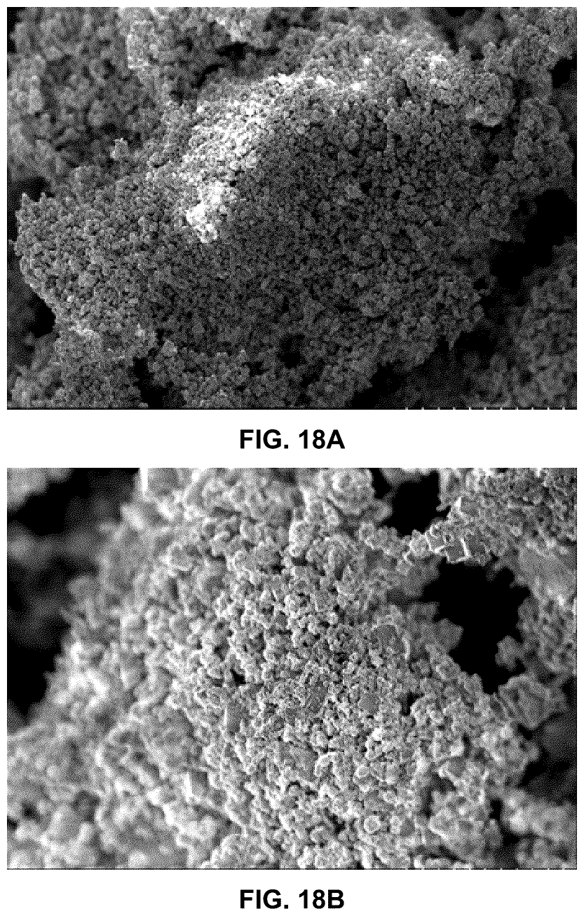

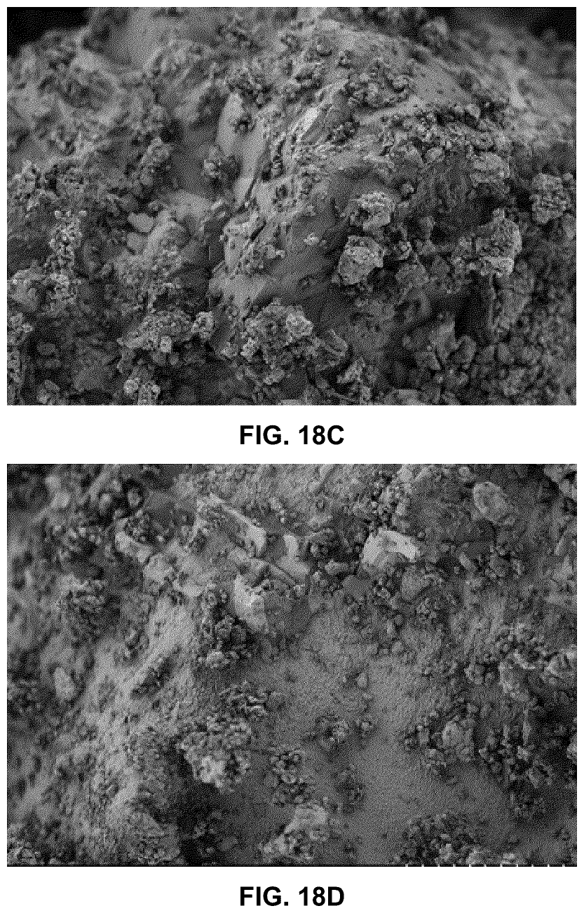

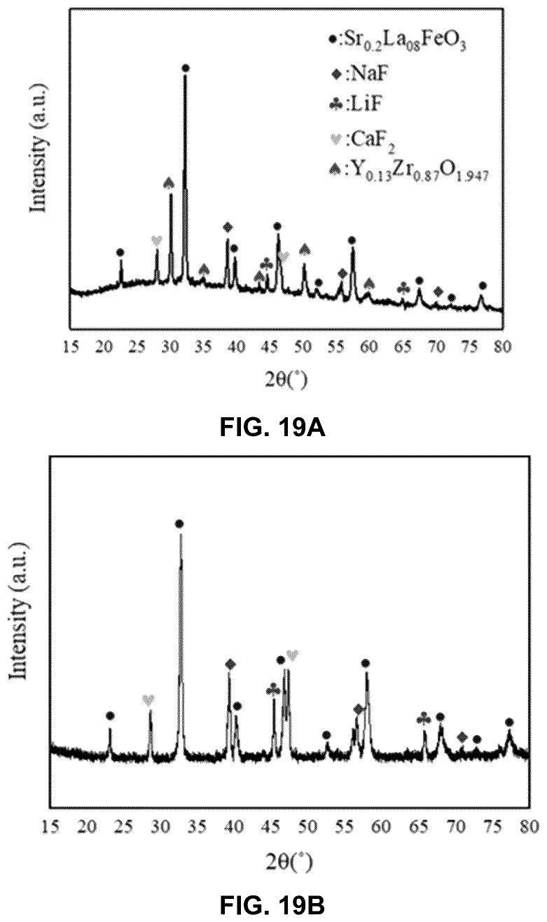

In the long-run test, porous perovskite oxide particles were used in the composite materials. The porosity of the perovskites was increased by the above-mentioned salt grinding method. The porous structure of perovskite oxide can be seen from the SEM image (FIG. 18A). In addition, FIG. 18B and FIG. 18C show the morphology of composite material before and after calcination, respectively. These figures demonstrated that once the salt melts and expands its volume, the liquid phase fills the pores of the perovskite oxide. As shown in FIG. 18D, the morphology of the composite material was also maintained after 100 cycles. Additionally, the XRD patterns of the La_{0.5}Sr_{0.2}FeO_{3-δ}:NaF—LiF—CaF₂ before and after 100 cycles in FIGS. 19A-19B. The additional peak corresponds to the thin layer of YSZ that was put on the bottom of the pan during the experiment. Not a significant change in the phases of perovskite and salts was seen. This shows that no reactions between La_{0.5}Sr_{0.2}FeO₃-6 and the fluoride salt happened, thus the OMS composite showed stable performance during 100 cycles.

### Component Compatibility

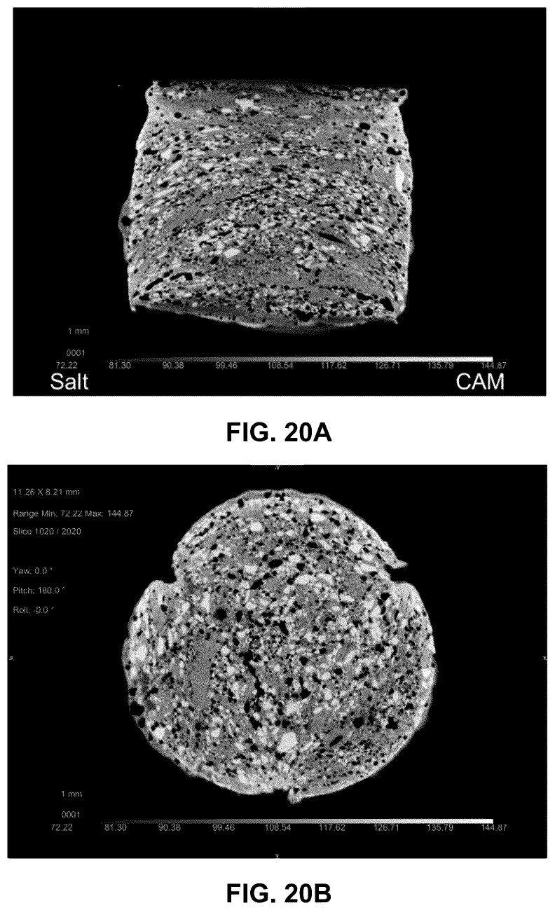

The compatibility between Ca₂AlMnO₅ and binary chloride molten salt was tested using Nano-computed tomography (Nano-CT). The composite materials were first packed with 10 tons of pressure into a pellet of 6 mm O.D. and 10 mm height. Then, the pellet was calcined at 550° C. in a tube furnace for one hour. As shown in FIGS. 20A-20B, Ca₂AlMnO₅ particles were fully compatible with molten salt. No significant physical phase segregation was observed, indicating the physical stability of the OMS composite material.

### Reaction Enthalpy

DFT was used to conduct high-throughput screening of A-site and/or B-site substituted SrFeO₃ based perovskites with 2401 different compositions. Oxygen capacity, reaction enthalpy as well as material price were considered to pre-screen the suitable candidates for TCES. Then, some perovskite candidates were synthesized using the solid-state method. The oxygen releases under different redox conditions were measured in a TGA. The non-stoichiometry of the perovskite oxide was further obtained by varying the oxygen concentrations and temperatures. The corresponding reaction enthalpy was calculated via Van′t Hoff equation.

As aforementioned, standard reaction enthalpy and redox oxygen capacity are critical for TCES systems since their product determines the overall TCES density. Redox oxygen capacity is closely related to the operating temperature. As such, multiple criteria are required for choosing a suitable candidate for TCES. Gibbs free energy change ΔG has been demonstrated as an adequate descriptor for redox oxygen capacity based on previous publications. At a specific temperature ΔG needs to be within a suitable range to facilitate oxygen release and uptake, while a higher standard reaction enthalpy ΔH for a similar oxygen capacity can lead to a higher energy storage density. Thus, both ΔG and ΔH were used as the descriptors for the high-throughput DFT calculations on the 2,003 SrₓA₁₋ₓFe_{y}B_{1-y}O_{δ} candidates.

The simulation results also revealed a less significant correlation between ΔH and temperature, which has been reported in many previous studies. The ΔH heatmaps of the screened perovskite candidates are shown in FIGS. 2C-3D. In general, the computed ΔH gradually increased with the 5, which was consistent with most reported results for the perovskites with the cubic structure.

In terms of the operating conditions, various materials can be developed depending on the temperatures of heat sources and oxygen partial in the working fluid. 400-800° C., which is widely compatible with thermal power plants and many other industrial processes, was chosen in this study for material design and experimental validation. At the upper (800° C.) and the lower (400° C.) limits, the suitable range of ΔG for triggering the oxygen release can be directly calculated from the pressure swing using the following equation:

$$Δ G = - \frac{1}{2} RTln \frac{{P}_{{O}_{2}}}{{P}^{0}} \qquad Eq . ( 3 )$$

Even though most of the previous studies on material design treated the samples in the atmosphere with considerably low oxygen concentrations, an oxygen concentration closer to air is more feasible and energy-efficient for TCES. A pressure swing between P_{O2}=0.01 and P_{O2}=0.2 atm was utilized in this study when considering both the heat charging and discharging processes. This corresponds to ΔG ranges of 0.047-0.134 eV at 400° C., and 0.074-0.213 eV at 800° C. Based on a previous investigation, the DFT simulation error is −0.3 eV to 0.5 eV. Therefore, the suitable materials should meet the requirements for ΔG_{DFT} as set out previously.

Previous experiments indicate that δ dramatically varies among different TCES materials but is usually less than 0.3 under a moderate oxygen partial pressure >0.001 atm. As such, the initial focus was on the δ range between 0-0.25 and used the average ΔG results of ΔG_{0-0.125} and ΔG_{0.125-0.25} for the pre-screening step.

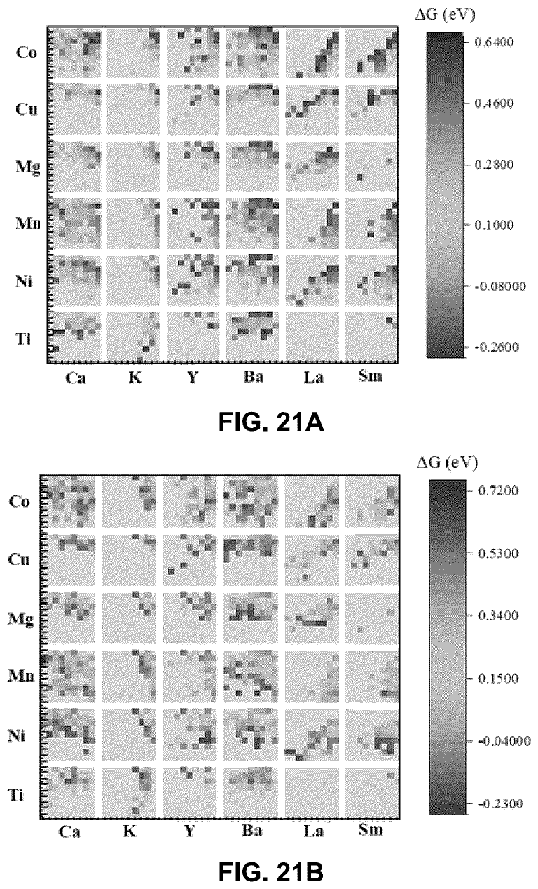

As shown in FIGS. 21A-21B, 775 samples remained on the screening list. In the heatmaps of ΔG, the abscissas represent the dopant fraction (x) of Sr in the SrₓA₁₋ₓFe_{y}B_{1-y}O_{b} perovskite, while the ordinates are the dopant fraction (y) of Fe. Most samples containing Ti, Sm, and La and Cu were removed due to undesirable ΔG. Ti, Sm, and La dopants tend to increase the temperatures for oxygen release, leading to an excessively large ΔG. In contrast, Cu dopant has the opposite impact on ΔG. The probability distribution of ΔH for the screened candidates within the entire δ range of 0-0.5 is shown in FIG. 21A. It is clearly seen that ΔH can be tuned over a large range of −0.3˜3.3 eV with various dopant types and concentrations. 80% of the materials fell within the range of 0.3-1.5 eV, i.e., 29-145 kJ/mol 0. The statistical summary of ΔH at different δ ranges is shown in FIG. 21B. ΔH overall increased with the oxygen vacancy, which was consistent with most of the findings in the literature. The broad range of ΔH at different δ ranges also indicates the necessity for the present discrete computation as a considerable number of the perovskite materials for TCES cannot achieve a large δ.

The redox oxygen capacities of selected materials under different conditions is listed in Table.4. 45% of the predicted materials released >0.15 wt % O₂ with the pressure swing between 0.2 atm O₂ to 0.01 atm O₂ at 400° C., and that number increased to 75% at 800° C. Considering the simulation errors, the computed ΔG can be used a reasonable reference for pre-screening materials with good oxygen capacity.

In the redox condition of 400° C./0.2 atm O₂ and 800° C./Ar, the highest oxygen capacity was 2.19 wt. % for Sr_{0.625}Ba_{0.375}FeO_{3-δ}, while the lowest one was 0.18 wt. % for CaFeO_{3-δ}. Sr_{0.75}Ba_{0.25}FeO_{3-δ} has the second largest oxygen release capacity by 2.04 wt. %, which might indicate that higher Ba doping in the A-site led to a higher oxygen capacity at lower temperatures when B-site only contained Fe. This is consistent with Bush et al.'s study on Sr₁₋ₓBaₓFeO_{3-δ} for air separation. However, when Ba doping was larger than 0.375 (e.g., Sr_{0.5}Ba_{0.5}FeO₃), phase segregation of BaFeO₃ and SrFeO₃ in the XRD patterns was observed, which might be due to the crystal distortion caused by the large atom of Ba. Pure phases could still be restored for high Ba dopants by substituting Fe with small amounts of Mg and Ti in the B-site, such as Sr_{0.25}Ba_{0.75}Fe_{0.875}Mg_{0.125}O_{3-δ} and Sr_{0.125}Ba_{0.875}Fe_{0.875}Ti_{0.125} O_{3-δ}. Even though the oxygen capacities were slightly lower, they all demonstrated sufficient oxygen capacity under an isothermal condition at 400° C., even with a redox condition of 0.2 atm/0.01 atm O₂. The general trend of Ba-based perovskites exhibited superior performance in O₂ redox capacity within the medium-high temperature range, which was promising for TCES applications that require medium-high temperatures, e.g., the recovery of industrial heat. Additionally, when the temperature was ramped from 400° C. to 800° C. at 0.2 atm O₂, oxygen release of most of the Ba-containing perovskites (from Sr_{0.625}Ba_{0.375}FeO_{3-δ} to Sr_{0.75}Ba_{0.25}Fe_{0.875}Mn_{0.125}O_{3-δ}) were all larger than 1 wt %. In other words, the energy storage of Ba-containing perovskites can be triggered with only a temperature swing in the air.

SrₓCa₁₋ₓFe_{y}Mn_{1-y}O₃ perovskites were another group of materials showing promising performance for TCES applications, which had the highest changes in δ owing to their smaller molar masses. As Mn-doping tended to increase the temperature window for oxygen release, a considerable amount of oxygen was released in the range of 800-1100° C. Sr_{0.375}Ca_{0.625}Fe_{0.125}Mn_{0.875}O₃, Sr_{0.25}Ca_{0.75}Fe_{0.75}Mn_{0.25}O₃, and Sr_{0.375}Ca_{0.625}Fe_{0.125}Mn_{0.875}O₃ all exhibited oxygen releases>2.5 wt. % under the redox condition between 400° C./0.2 atm O₂ and 1100° C./Ar. In particular, Sr_{0.375}Ca_{0.625}Fe_{0.125}Mn_{0.875}O₃ had an oxygen capacity >2 wt. % even with a redox condition between 400° C./0.2 atm O₂ and 1100° C./0.01 atm O₂. This moderate oxygen atmosphere would be a potential benefit for industrial TCES applications with flexible operation.

Among all the tested materials, A-site dopant types and concentrations appeared to have more significant effects on the redox capacity than B-sites. For instance, for perovskite co-doped with Sr—Ca in the A-site, higher Mn-doped materials released more substantial amounts of oxygen than Mg and Ti-doped ones. However, Mn-doping resulted in lower oxygen capacities in those materials co-doped with Sr—Ba. Additionally, increasing the doping amount of Mg and Ti adversely affected phase purity or redox performance, which was another factor that required consideration.

Based on the oxygen capacity under the redox condition between 400° C./0.2 atm O₂ and 800° C./Ar, 15 good materials with high oxygen release (>1 wt. %) and 2 unfavorable materials (<1 wt. %) with low oxygen release were selected to measure their reaction enthalpies. ΔH of all tested materials varied from 20 to 150 kJ/mol O, while δ almost covered the whole range of 0 to 0.5. In general, ΔH increased with the oxygen vacancy, which is consistent with most reported data of SrFeO₃-based perovskite. It is clear that the dopant types and concentrations significantly changed ΔH, but some general trends can be captured from the tested materials. Firstly, a trade-off between the oxygen release and the reaction enthalpy can be easily seen. As mentioned above, Ba doping tended to reduce the temperature window for oxygen release, but the corresponding ΔH was also lower compared to La-doped, Ca-doped, or un-doped samples. Mg-doping stabilized the SrₓBa₁₋ₓFeO_{3-δ} at high-Ba doping conditions and facilitated the oxygen release but negatively affected the ΔH. Additionally, δ of both Sr_{0.625}Ba_{0.375}FeO₃₋₆ and Sr_{0.75}Ba_{0.25}FeO₃₋₅ reached 0.45 at 800° C./0.01 atm O₂ condition, so their energy storage density would be limited by the insufficient oxidation. In other words, they might be suitable for TCES at an even lower temperature (<400° C.), which would be benefited from further oxidation and a smaller 5.

In contrast, Mn doping enhanced the temperature to release oxygen but concurrently led to a higher ΔH. For instance, for the three Sr_{0.25}Ca_{0.75}Fe_{y}Mn_{1-y}O_{3-δ} materials, ΔH significantly increased by about 100 kJ/mol 0 when the substitution of Mn in the B-site increased from 37.5% to 75%. Moreover, a small quantity of Mn-doping in Sr_{0.75}Ba_{0.25}FeO_{3-δ} significantly improved the oxygen release performance but barely affected ΔH, leading to an elevated energy density at the same condition. Among all the tested materials, Sr_{0.375}Ca_{0.625}Fe_{0.125}Mn_{0.875}O_{3-δ} displayed the highest ΔH of 160 kJ/mol 0 with Ab of 0.3 under a redox condition between 400° C./0.2 atm O₂ and 1000° C./Ar.

The chemical energy storage densities (ΔH_{chem}) of screened materials are summarized in Table.3. The redox reaction of Ba-doped samples can be easily triggered by the air. A higher temperature or a lower oxygen partial pressure only leads to a minor increase in ΔH_{chem}, especially for Sr_{0.25}Ba_{0.75}Fe_{0.575}Mg_{0.125}O_{3-δ}. Sr_{0.625}Ba_{0.375}FeO_{3-δ} exhibited the largest ΔH_{chem} of 67 kJ/kg_{ABO3} under a isobaric air condition between 400° C. and 800° C. In contrast, SrₓCa₁₋ₓFe_{y}Mg_{1-y}O_{3-δ} barely released O₂ and absorbed heat at low temperatures, but ΔH_{chem} was significantly improved when the temperature was above 800° C. Sr_{0.375}Ca_{0.625}Fe_{0.125}Mn_{0.875}O_{3-δ} achieved a ΔH_{chem} of 162 kJ/kg_{ABO3} under a redox condition between 400° C./0.2 atm O₂ and 800° C./0.01 atm O₂. The therotical energy densities of composite materials were also calculated for each individual perovskite. The composite material was assumed to contain 50 wt % of Li/Na binary eutatic carbonate salt (44 wt. % Li₂CO₃-56% K₂CO₃) and 50 wt % of perovskite oxide. The redox condition was assumed to be under 400° C./0.2 atm O₂ and 800° C./Ar or 400° C./0.2 atm O₂ and 1100° C./Ar. For the carbonate salts, the melting temperature is about 496° C., the heat of fusion is about 380 kJ/kg, and the specific heat capacity is about 2.36 kJ/kg-K. The specific heat capacity of the perovskite was assumed to be 0.8 kJ/kg-K. The composite materials under specific conditions were all considerably high.

Chemical energy storage densities of screened materials are provided in Table 7:

TABLE 7
Chemical Energy Storage Density of Screened Materials (kJ/kg_{AB03})

| | O₂ partial pressure | | | | | | | |
|---|---|---|---|---|---|---|---|---|
| | 0.2 atm | | 0.01 atm | | Ar | | Composite | |
| | Temperature region (° C.) | | | | | | | |
| | 400-800 | 400-1100 | 400-800 | 400-1100 | 400-800 | 400-1100 | 400-800 | 400-1100 |
| Sr_{0.625}Ba_{0.375}FeO_{3-δ} | 67 | 89 | 76 | 92 | 96 | 99 | 872 | 1346 |
| Sr_{0.75}Ba_{0.25}FeO_{3-δ} | 50 | 60 | 60 | 66 | 66 | 71 | 858 | 1332 |
| Sr_{0.875}La_{0.125}Fe_{0.75}Mn_{0.25}O_{3-δ} | 19 | 42 | 42 | 71 | 71 | 138 | 891 | 1365 |
| Sr_{0.875}Ba_{0.125}Fe_{0.875}Mn_{0.125}O_{3-δ} | 23 | 40 | 40 | 53 | 58 | 67 | 856 | 1330 |
| Sr_{0.75}Ba_{0.25}Fe_{0.875}Mn_{0.125}O_{3-δ} | 20 | 59 | 40 | 75 | 80 | 108 | 876 | 1350 |
| Sr_{0.375}Ca_{0.625}Fe_{0.125}Mn_{0.875}O_{3-δ} | 17 | 88 | 49 | 162 | 123 | 233 | 939 | 1413 |
| SrFe_{0.875}Mn_{0.125}O_{3-δ} | 41 | 57 | 52 | 74 | 79 | 114 | 879 | 1353 |
| Sr_{0.25}Ca_{0.75}Fe_{0.25} Mn_{0.75}O_{3-δ} | 9 | 54 | 28 | 111 | 94 | 223 | 934 | 1408 |
| Sr_{0.25}Ca_{0.75}Fe_{0.375} Mn_{0.625}O_{3-δ} | 8 | 44 | 20 | 101 | 84 | 190 | 917 | 1391 |
| Sr_{0.875}La_{0.125}Fe_{0.625} Mn_{0.375}O_{3-δ} | 5 | 9 | 13 | 25 | 42 | 79 | 862 | 1336 |
| Sr_{0.25}Ba_{0.75}Fe_{0.875}Mg_{0.125}O_{3-δ} | 46 | 58 | 55 | 61 | 61 | 65 | 855 | 1329 |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Aftab, W. et al, Energy Environ. Sci. 2021, 14, 4268.
2. Airò Farulla, G. et al, Appl. Sci. 2020, 10, 3142.
3. Alves, B. Global thermal energy storage capacity 2019-2030, <https://www.Statista.Com/statistics/1307219/thermal-energy-storage-capacity-global/> (Accessed Nov. 10, 2022).
4. André, L. et al, Energies 2020, 13. 5859.
5. Anisimov, V. V. et al, Phys Rev B Condens Matter 1991, 44, 943.
6. Antipinskaya, E. A., J. Energy Storage 2022, 53, 105175.
7. Arias, B. et al, Appl. Energy 2014, 132, 127-136.
8. Babiniec, S. M. et al, AIP Conference Proceedings 1734, 050006 2016.
9. Babiniec, S. M. et al, Sol. Energy 2015, 118, 451.
10. Babiniec, S. M., Int. J. Energy Res 2016, 40, 280.
11. Bakken, E. et al, Solid State Ion. 2005, 176, 217.
12. Bauer, T. et al., Molten Salts Chemistry 2013, 415.
13. Bell, S. et al, Renew. Sust. Energ. Rev. 2019, 114, 109328.
14. Benato, A. et al, J. Energy Storage 2018, 17, 29.
15. Blochl, P. E. Phys Rev B Condens Matter 1994, 50, 17953.
16. BP, Bp statistical review of world energy, 2022.
17. Bulfin, B. et al, Chem. Eng. Sci. 2019, 203, 68.
18. Bulfin, B. et al, J. Mater. Chem. A 2017, 5, 7912.
19. Bush, H. E. et al, Solid State Ion. 2021, 368, 115692.
20. Caraballo, A. et al, Energies 2021, 14, 1197.
21. Chang, J. et al, Korean J. Chem. Eng. 2021, 38, 1333.
22. Chen, et al, ACS Sustain. Chem. Eng. 2020, 8, 7928.
23. Chen, H. et al, Progress in Natural Science 2009, 19, 291.
24. Darwish, E. et al, Processes 2021, 9, 1817.
25. Dou, J. et al, ChemSusChem 2020, 13, 385.
26. Emery, A. A. et al, Sci Data 2017, 4, 170153.
27. Ezbiri, M. et al, J Mater Chem A Mater 2017, 5, 4172.
28. Fan, J. et al, Adv Sci 2022, 9, 2202811.
29. Fanglei, I I et al, 2020 5th Asia Conference on Power and Electrical Engineering (ACPEE), 2020, 607.
30. Farr, T. P. et al, Materials (Basel) 2020, 13, 5123.
31. Flores-Granobles, et al, Energy Environ. Sci. 2020, 13, 1923.
32. Frisch, M. J. et al, Gaussian 16, revision c. 01, Gaussian Inc., Wallingford, CT, USA, 2016.
33. Galinsky, N. et al, Appl. Energy 2015, 157, 358.
34. Galinsky, N. et al, Appl. Energy 2016, 174, 80.
35. Gokon, N. et al, Energy 2019, 171, 971.
36. Görke, R. H. et al, Int. J. Greenh. Gas Control. 2020, 94, 102891.
37. Gryaznov, D. et al, J. Maier, Solid State Ion. 2014, 254, 11.
38. Gür, T. M. Energy Environ. Sci. 2018, 11, 2696.
39. Hautier, G. et al, Physical Review B 2012, 85, 155208.
40. Hawwash, A. A. et al, Energy Procedia 2017, 141, 310.
41. Imponenti, L. et al, ECS Transactions 2016, 72, 11.
42. Imponenti, L. et al, Sol. Energy 2017, 151, 1.
43. Imtiaz, Q. et al, Energy Technol. 2013, 1, 633.
44. Jain, A. et al, Computational Materials Science 2011, 50, 2295.
45. Jia, T. et al, Appl. Energy 2021, 281, 116040.
46. Jia, T. et al, Phys. Chem. Chem. Phys. 2020, 22, 16721.
47. Jin, F. et al, ACS Appl. Mater. Interfaces 2021, 13, 3856.
48. Kesić, Ž. et al, Fuel Process. Technol. 2016, 143, 162.
49. Kresse, G. et al, Phys Rev B Condens Matter 1996, 54, 11169.
50. Krzystowczyk, E. et al, Phys. Chem. Chem. Phys. 2020, 22, 8924.
51. Lau, C. Y. et al, Energy Environ. Sci. 2017, 10, 818.
52. Lee, Y. L. et al, Physical Review B: Condensed Matter and Materials Physics 2009, 80, 308.
53. Liu, C. et al, Science Bulletin 2017, 62, 231.
54. Luongo, G. et al, Phys. Chem. Chem. Phys. 2020, 22, 9272.
55. Ma, Z. et al, Design of particle-based thermal energy storage for a concentrating solar power system, ASME 2017 11th International Conference on Energy Sustainability.
56. Mastronardo, E. et al, J. Energy Storage 2021, 40, 102793.
57. Nair, M. M. et al, Sustainable Energy & Fuels 2018, 2, 843.
58. Pardo, P I et al, Renew. Sust. Energ. Rev. 2014, 32, 591.
59. Pelay, U. et al, Renew. Sust. Energ. Rev. 2017, 79, 82.
60. Perdew, J. P. et al, Phys. Rev. Lett. 1996, 77, 3865.
61. Popczun, E. J. et al, J. Mater. Chem. A 2020, 8, 2602.
62. Rahman, M. M. et al, Energy Convers. Manage. 2020, 223, 113295.
63. Saghafifar, M. et al, Appl. Energy 2020, 279, 115553.
64. Saghafifar, M. et al, Chem. Eng. J. 2021, 423, 128789.
65. Saha, S. et al, Clean Technologies and Environmental Policy 2020, 23, 531.
66. Salgado-Pizarro, R. et al, J. Energy Storage 2022, 51, 104377.
67. Schmidt, M. et al, Frontiers in Energy Research 2020, 8:137.
68. Snini, K. et al, J. Alloys Compd. 2021, 874, 159866.
69. Stoffel, R. P. et al, Angew. Chem. Int. Ed. Engl. 2010, 49, 5242.
70. Sunku Prasad, J. et al, Appl. Energy 2019, 254, 113733.
71. Takacs, M. et al, Acta Mater. 2016, 103, 700.
72. Togo, A. et al, Scripta Mater. 2015, 108, 1.
73. Tumiran, T. et al, Renewable Energy 2021, 163, 561.
74. Vieten, J. et al, Energy Environ. Sci. 2019, 12, 1369.
75. Vieten, J. et al, Solid State Ion. 2017, 308, 149.
76. Wang, X. et al, Chem. Mater. 2021, 33, 2446.
77. Wang, X. et al, Energy Environ. Sci. 2022, 15, 1512.
78. Wang, Y. et al, IEEE Transactions on Power Systems 2020, 35, 1178.
79. Wexler, R. B. et al, J. Am. Chem. Soc. 2021, 143, 13212.
80. Wu, S. et al, Energy Convers. Manage. 2018, 168, 421.
81. Yang, Y. et al, Energies 2021, 14, 6847.
82. Yang, Z. et al, Solid State Ion. 2005, 176, 89.
83. Yilmaz, D. et al, Ind. Eng. Chem. Res. 2021, 60, 1250.
84. Zhao, Y. et al, Appl. Energy 2020, 280, 115950.

What is claimed is:

1. A composite material comprising a redox active oxide and a molten salt.

2. An oxide molten salt (OMS) composite material comprising the composite material of claim 1, wherein the redox active oxide is a perovskite-oxide, wherein the redox active oxide comprises a porous matrix, and wherein a plurality of pores in the porous matrix are filled with the molten salt.

3. The OMS composite material of claim 2, further comprising an outer shell comprising a second perovskite oxide, wherein the outer shell comprises Al₂O₃, ZrO₂, CeO₂ or any combination thereof.

4. The OMS composite material of claim 2, wherein the molten salt comprises a unary salt or a mixture of two or more salts.

5. The OMS composite material of claim 2, wherein the molten salt comprises a chloride salt, a carbonate salt, a fluoride salt, a sulfate salt, a phosphate salt, a nitrate salt, a tetrafluoroborate salt, or any combination thereof.

6. The OMS composite material of claim 5, wherein the chloride salt comprises CaCl₂, NaCl, KCl, MgCl₂, LiCl, ZnCl₂, CsCl, SrCl₂, CrO₃, or any combination thereof.

7. The OMS composite material of claim 6, wherein the carbonate salt comprises Li₂CO₃, Na₂CO₃, K₂CO₃, or any combination thereof.

8. The OMS composite material of claim 2, wherein the molten salt is from about 10 wt % to about 90 wt % of the composite material.

9. The OMS composite material of claim 2, wherein the perovskite-oxide comprises a perovskite structure, a brownmillerite structure, a double perovskite structure, or any combination thereof.

10. The OMS composite material of claim 9, wherein the perovskite structure is selected from CaₓA₁₋ₓMn_{y}B_{1-y}O_{3-δ}, LaₓA₁₋ₓFe_{y}B_{1-y}O_{3-δ}, SrₓA_{1-δ}Fe_{y}B_{1-y}O_{3-δ}, or a combination thereof;
wherein A is selected from the group Ca, Sr, Ba, La, or a combination thereof; and
wherein B is selected from Fe, Mn, Al, Ti, Mg, Ce, Co, Cr, or a combination thereof.

11. The OMS composite material of claim 10, wherein the double perovskite structure is CaₓA₂₋ₓMnAlO_{5-δ};
wherein A is selected from Sr, Ba, or any combination thereof.

13. The OMS composite material of claim 10, wherein x and y are independently from about 0 to about 1.

14. The OMS composite material of claim 2, wherein the perovskite-oxide comprises SrₓA₁₋ₓFe_{y}B_{1-y}O_{3-δ};
wherein A comprises Ba, Ca, La, or any combination thereof;
wherein B comprises Mg, Mn, Ti, or any combination thereof;
wherein x is from 0 to 1;
wherein y is from 0.125 to 1; and
wherein δ is from 0 to 0.5.

15. The OMS composite material of claim 14, wherein x is from 0.125 to 0.375 and y is from 0.125 to 0.25.

16. The OMS composite material of any one of claims 16-19, wherein the perovskite-oxide comprises SrFeO_{3-δ}, Sr_{0.75}Ba_{0.25}Fe_{0.875}Mg_{0.125}O_{3-δ}, SrFe_{0.875}Mn_{0.125}O_{3-δ}, Sr_{0.875}Ba_{0.125}FeO_{3-δ}, Sr_{0.75}Ba_{0.25}FeO_{3-δ}, Sr_{0.625}Ba_{0.375}FeO_{3-δ}, Sr_{0.625}Ba_{0.375}Fe_{0.875}Mg_{0.125}O_{3-δ}, Sr_{0.875}Ba_{0.125}Fe_{0.875}Mn_{0.125}O_{3-δ}, Sr_{0.875}Ca_{0.125}Fe_{0.875}Mn_{0.125}O_{3-δ}, Sr_{0.25}Ba_{0.75}Fe_{0.875}Mg_{0.125}O_{3-δ}, SrFe_{0.75}Ti_{0.25}O_{3-δ}, Sr_{0.125}Ba_{0.875}Fe_{0.875}Ti_{0.125}O_{3-δ}, Sr_{0.625}Ba_{0.375}Fe_{0.875}Mn_{0.125}O_{3-δ}, Sr_{0.75}Ba_{0.25}Fe_{0.875}Mn_{0.125}O_{3-δ}, Sr_{0.875}Ba_{0.125}Fe_{0.625}Ti_{0.375}O_{3-δ}, Sr_{0.75}Ca_{0.25}Fe_{0.75}Ti_{0.25}O_{3-δ}, Sr_{0.75}Ca_{0.25}Fe_{0.75}Mn_{0.25}O_{3-δ}, Sr_{0.25}Ba_{0.75}Fe_{0.875}Ti_{0.125}O_{3-δ}, Sr_{0.875}Ca_{0.125}Fe_{0.625}Ti_{0.375}O_{3-δ}, Sr_{0.75}Ca_{0.25}Fe_{0.625}Mn_{0.375}O_{3-δ}, Sr_{0.75}La_{0.25}Fe_{0.375}Mn_{0.625}O_{3-δ}, Sr_{0.875}La_{0.125}Fe_{0.75}Mn_{0.25}O_{3-δ}, Sr_{0.875}Ca_{0.125}Fe_{0.875}Mg_{0.125}O_{3-δ}, Sr_{0.875}La_{0.125}Fe_{0.625}Mn_{0.375}O_{3-δ}, Sr_{0.125}Ca_{0.875}Fe_{0.25}Mn_{0.75}O_{3-δ}, Sr_{0.75}La_{0.25}Fe_{0.75}Mg_{0.25}O_{3-δ}, Sr_{0.25}Ca_{0.75}Fe_{0.25}Mn_{0.75}O_{3-δ}, Sr_{0.75}Ba_{0.25}Fe_{0.625}Ti_{0.375}O_{3-δ}, Sr_{0.75}Ba_{0.25}Fe_{0.5}Ti_{0.5}O_{3-δ}, Sr_{0.25}Ca_{0.75}Fe_{0.375}Mn_{0.625}O_{3-δ}, Sr_{0.625}Ca_{0.375}Fe_{0.625}Ti_{0.375}O_{3-δ}, Sr_{0.375}Ca_{0.625}Fe_{0.125}Mn_{0.875}O_{3-δ}, Sr_{0.375}Ca_{0.625}Fe_{0.5}Mn_{0.5}O_{3-δ}, Sr_{0.625}Ca_{0.375}Fe_{0.5}Ti_{0.5}O_{3-δ}, Sr_{0.25}Ca_{0.75}Fe_{0.625}Ti_{0.375}O_{3-δ}, Sr_{0.5}Ca_{0.5}Fe_{0.625}Ti_{0.375}O_{3-δ}, Sr_{0.25}Ca_{0.75}Fe_{0.625}Mn_{0.375}O_{3-δ}, BaFe_{0.625}Mn_{0.375}O_{3-δ}, Sr_{0.375}Ca_{0.625}Fe_{0.75}Ti_{0.25}O_{3-δ}, Sr_{0.125}Ca_{0.875}Fe_{0.75}Mn_{0.25}O_{3-δ}, Sr_{0.25}Ca_{0.75}Fe_{0.75}Mn_{0.25}O_{3-δ}, SrFe_{0.375}Mn_{0.625}O_{3-δ}, Sr_{0.125}Ca_{0.875}Fe_{0.25}Ti_{0.75}O_{3-δ}, Sr_{0.125}Ca_{0.875}Fe_{0.625}Ti_{0.375}O_{3-δ}, Sr_{0.5}La_{0.5}Fe_{0.125}Mn_{0.875}O_{3-δ}, Sr_{0.125}Ca_{0.875}Fe_{0.25}Mn_{0.75}O_{3-δ}Sr_{0.375}Ca_{0.625}Fe_{0.125}Mn_{0.875}O_{3-δ}, or any combination thereof.

17. A system for thermochemical energy storage and release, the system comprising:
(a) an endothermic charge stage, wherein the OMS composite material of claim 2 has a δ of 0 at a beginning time point of the endothermic charge stage, and wherein the OMS composite material is exposed to heat, thereby releasing molecular oxygen such that δ increases to greater than 0 at an ending time point of the endothermic charge stage; and
(b) an exothermic discharge stage, wherein the OMS composite material has a δ greater than 0 at a beginning time point of the exothermic discharge stage, wherein molecular oxygen combines with the OMS composite material such that δ decreases towards 0 and heat is released at an ending time point of the exothermic discharge stage.

18. The system of claim 17, wherein the endothermic charge stage operates with an oxygen partial pressure of from about 0.01 atm to about 5 atm.

19. The system of claim 17, wherein the endothermic charge stage and the exothermic discharge stage operate with a temperature difference of from about 50° C. to about 500° C.

20. The system of claim 17, wherein adsorption and desorption of CO₂ are used to trigger heat release or storage.
